(19) United States
(12) Patent Application Publication
(10) Pub. No.: US 2022/0004174 A1
(43) Pub. Date: Jan. 6, 2022

(54) PREDICTIVE ANALYTICS MODEL MANAGEMENT USING COLLABORATIVE FILTERING

(71) Applicant: Intel Corporation, Santa Clara, CA (US)

(72) Inventors: Samudyatha C. Kaira, Portland, OR (US); Rita H. Wouhaybi, Portland, OR (US); Rajesh Poornachandran, Portland, OR (US)

(73) Assignee: Intel Corporation, Santa Clara, CA (US)

(21) Appl. No.: 17/480,168

(22) Filed: Sep. 21, 2021

Related U.S. Application Data
(60) Provisional application No. 63/083,895, filed on Sep. 26, 2020.

(51) Int. Cl. G05B 19/418; G06K 9/62

(52) U.S. Cl. CPC G05B 19/41875; G05B 19/4183; G06K 9/6218; G05B 19/41885

(57) ABSTRACT

In one embodiment, a computing device includes interface circuitry and processing circuitry. The processing circuitry receives, via the interface circuitry, a data stream captured at least partially by sensor(s), which contains feature values corresponding to an unlabeled instance of a feature set. The processing circuitry then groups the data stream into a data stream group, which is assigned from a set of data stream groups based on the feature values in the data stream. The processing circuitry then selects a predictive model for the data stream group from a set of predictive models, which are each trained to predict a target variable for a corresponding data stream group. The processing circuitry then predicts the target variable for the data stream using the predictive model, which infers the target variable based on the set of feature values in the data stream.

### CROSS-REFERENCE TO RELATED APPLICATION

This patent application claims the benefit of the filing date of U.S. Provisional Patent Application Ser. No. 63/083,895, filed on Sep. 26, 2020, and entitled “PREDICTIVE ANALYTICS MODEL MANAGEMENT USING COLLABORATIVE FILTERING,” the contents of which are hereby expressly incorporated by reference.

### TECHNICAL FIELD

This disclosure relates in general to the field of machine learning and artificial intelligence, and more particularly, though not exclusively, to efficiently developing, deploying, and maintaining predictive analytics models.

### BACKGROUND

Predictive analytics using machine learning and artificial intelligence can be leveraged for a wide variety of use cases and applications, which generally involve predicting some type of future event or circumstance based on patterns of data captured for past events. Developing and maintaining large-scale predictive analytics use cases can be challenging, however, particularly with respect to performance and scalability. As an example, predictive analytics could potentially be leveraged in an industrial environment, where many different types of machines and equipment are often used to perform a variety of tasks. As the number of machines in the environment grows, however, training a single predictive analytics model for all of the machines yields poor performance, while training a separate model for each machine becomes impractical or altogether infeasible.

### BRIEF DESCRIPTION OF THE DRAWINGS

The present disclosure is best understood from the following detailed description when read with the accompanying figures. It is emphasized that, in accordance with the standard practice in the industry, various features are not necessarily drawn to scale, and are used for illustration purposes only. Where a scale is shown, explicitly or implicitly, it provides only one illustrative example. In other embodiments, the dimensions of the various features may be arbitrarily increased or reduced for clarity of discussion.

FIG. 1 illustrates an example embodiment of a predictive analytics model management system for an industrial use case.

FIG. 2 illustrates an example system architecture for a predictive analytics model management system.

FIG. 3 illustrates a current series graph for an example of grouping data streams for predictive analytics model management.

FIG. 4 illustrates an example of a computing device for predictive analytics model management in accordance with certain embodiments.

FIG. 5 illustrates a flowchart for an example embodiment of predictive analytics model management.

FIG. 6 illustrates an overview of an edge cloud configuration for edge computing.

FIG. 7 illustrates operational layers among endpoints, an edge cloud, and cloud computing environments.

FIG. 8 illustrates an example approach for networking and services in an edge computing system.

FIG. 9A provides an overview of example components for compute deployed at a compute node in an edge computing system.

FIG. 9B provides a further overview of example components within a computing device in an edge computing system.

FIG. 10 illustrates an example software distribution platform to distribute software in accordance with certain embodiments.

### EMBODIMENTS OF THE DISCLOSURE

The following disclosure provides many different embodiments, or examples, for implementing different features of the present disclosure. Specific examples of components and arrangements are described below to simplify the present disclosure. These are, of course, merely examples and are not intended to be limiting. Further, the present disclosure may repeat reference numerals and/or letters in the various examples. This repetition is for the purpose of simplicity and clarity and does not in itself dictate a relationship between the various embodiments and/or configurations discussed. Different embodiments may have different advantages, and no particular advantage is necessarily required of any embodiment.

Predictive Analytics Model Management Using Collaborative Filtering

Predictive analytics using machine learning and artificial intelligence can be leveraged for a wide variety of use cases and applications, which generally involve predicting some type of future event or circumstance based on patterns of data captured for past events versus data captured in real time.

In industrial settings, for example, one of the leading use cases of predictive analytics is predictive maintenance, where data generated by machines and sensors is used to predict when a particular machine or production line needs maintenance. The algorithms and models developed for predictive maintenance use cases typically aim to minimize downtime and optimize maintenance frequency.

Many other families of predictive analytics use cases are also emerging—both in industrial settings and beyond—which generally involve predicting some type of event or circumstance that will occur in the future. Depending on the particular use case, the predicted event may be a desirable event or an undesirable event. Moreover, similar to predictive maintenance, the algorithms and models developed for these use cases often use data generated by machines and sensors to generate predictions. The underlying input data—which tends to be heavily represented using time-series data—can include any representation of data from any type or combination of modalities, including configuration and performance data captured by machines and sensors, visual data (e.g., video) captured by cameras and other visual sensors, and so forth.

In many cases, predictive analytics for various types of events are implemented by software modules that feed into a larger application, and the larger application takes certain actions based on the predictions, such as actions designed to minimize or maximize the likelihood of the predicted events actually occurring (e.g., depending on whether the events are desirable or undesirable). These various use cases are often referred to generally as predictive analytics.

For large-scale deployments of predictive analytics—such as in a large industrial factory with numerous types of machines and equipment used for a variety of different tasks—predictive analytics models are typically developed and trained using a limited (e.g., representative) set of machines, such as test machines in a lab environment or pilot machines on the factory floor. This development process faces various challenges, however, particularly with respect to performance and scalability.

As an example, an automotive factory that manufactures automobiles may have thousands of autonomous robots on its production line. Each robot is typically equipped with a tool of some kind—such as a glue gun, welding gun, riveting machine, or screwdriver—which the robot uses to perform a specific task required to assemble an automobile (e.g., performing welding using a welding gun to assemble a car chassis). In particular, each robot performs its assigned task based on specific reference parameters that control how the task is to be performed.

While predictive analytics could potentially be leveraged for a variety of use cases on the production line—such as predictive maintenance and quality control—a predictive analytics model would typically be trained with a limited sample space that only includes data from the machines in a limited development environment (e.g., test machines a lab or pilot machines on the factory floor). When a single predictive analytics model is used to represent a large number of machines, however, the model might not satisfy the requisite key performance indicators (KPIs) for a particular use case, such as the requisite level of prediction accuracy across all machines.

Thus, a data scientist faces a dilemma when developing these large-scale predictive analytics:
(1) Develop a single model to represent all machines on the factory floor: this approach typically translates into a hit in accuracy and yields a very large model that requires significant amount of compute resources at each node during execution, but it also makes the development process more manageable since there is only one model to develop, test, tune, and maintain; or
(2) Develop a separate model for each machine: this approach typically improves accuracy and yields smaller models that require less compute resources at each node during execution, but in a large-scale production environment with hundreds or even thousands of robots or machines, the development, maintenance, and deployment of these models is often performed manually and becomes very time consuming (which may render this approach impractical or altogether infeasible).

Facing these issues, one potential solution is for the data scientist to find a middle ground that strikes an appropriate balance between performance and scalability, such as manually grouping machines with similar characteristics and then developing one model for each group of machines. In a large-scale production environment, however, the grouping process itself still tends to be a tedious manual process. Similarly, once the models for each machine group have been developed and deployed, maintaining the deployment can also be tedious—whenever a new machine is deployed on the floor or an existing machine is reconfigured, the machine must be manually assigned or reassigned to the appropriate group. In particular, scaling to a large set of machines requires constant feedback from a process expert to determine and redefine machine grouping rules based on data characteristics—this constant manual intervention makes the process of scaling very time consuming and error prone.

Moreover, even for a single model, the process of manually collecting and cleaning data—and setting up training infrastructure for a growing set of machines and their associated data—can be a very tedious and time-consuming process. Further, these manual approaches are incapable of factoring in and dynamically adapting/scaling based on real-time changes to an operating environment, such as changes in an autonomous robot/agent's ambience, the quality of materials, and so forth.

Accordingly, this disclosure presents a solution for efficiently developing, deploying, and maintaining predictive analytics models using collaborative filtering. In particular, the described solution implements predictive analytics model management using collaborative filtering (PAMMCF) to enable large-scale development and deployment of predictive analytics, which opens the door to numerous use cases that were previously impractical or infeasible, such as industrial use cases that improve the level of automation, scalability, and performance of next-generation industrial processes and technologies for the next industrial revolution (e.g., the 4th Industrial Revolution or “Industry 4.0”). The described solution is described in detail throughout this disclosure in connection with the referenced figures.

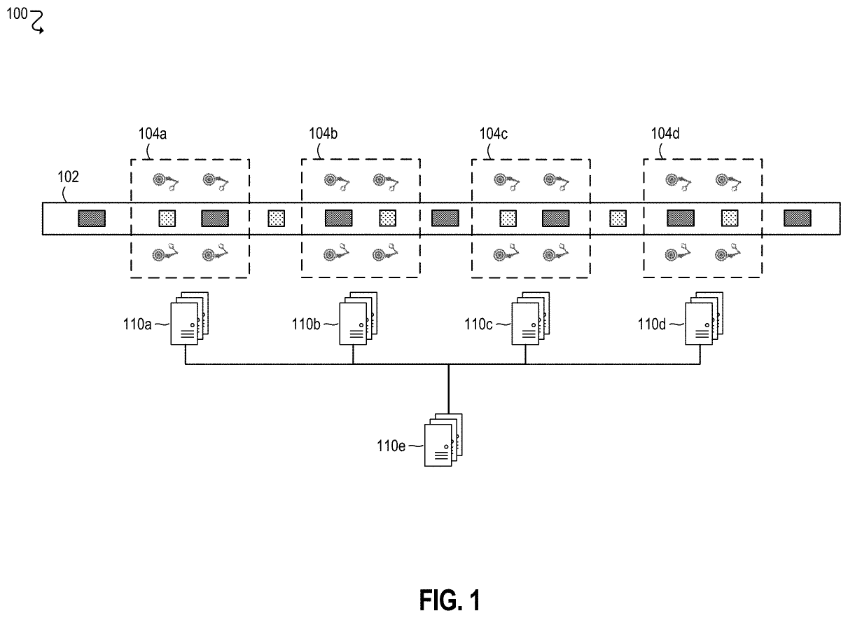

FIG. 1 illustrates an example embodiment of a predictive analytics model management system 100 for an industrial use case. In the illustrated example, the industrial use case involves product manufacturing on a production line 102 in a factory.

In the illustrated example, the production line 102 is organized into a series of modular cells 104a-d throughout the factory floor, and products that are being assembled (e.g., vehicles) move down the line 102 from cell to cell. Each cell 104a-d contains a collection of devices and equipment 105 for performing certain tasks required to assemble the product, such as multiple autonomous robots equipped with certain tool(s).

Moreover, various compute resources 110a-d are deployed to control the tasks performed in each cell 104a-d. In the illustrated embodiment, for example, the compute resources 110a-d in each cell 104a-d include controller(s) for the robots, controller(s) for the tools used by the robots, and a control computer with a user interface for the factory operators to control the particular cell (e.g., an Industrial PC (IPC)). The compute resources 110a-d in each cell 104a-d also interface with a predictive analytics server 110e, which is used to leverage predictive analytics on the production line 102. As explained further below, for example, predictive analytics can be leveraged for a variety of use cases on the production line, such as predictive maintenance and quality control, among other examples.

As an example, an automotive factory that manufactures automobiles may have thousands of autonomous robots distributed throughout the respective cells of a production line. Each robot is typically equipped with a tool of some kind—such as a glue gun, welding gun, riveting machine, pump, or screwdriver—which the robot uses to perform a specific task required to assemble an automobile. For example, many of the robots (e.g., hundreds or even thousands) may use a welding gun to perform spot welds to weld pieces of metal together, such as to assemble the chassis of a vehicle. For a large factory that produces hundreds or even thousands of vehicles per day—with thousands of welds required per vehicle—millions of welds can be performed in a single day of production. For example, assuming a production rate of 1,000 vehicles per day with 5,000 welds required per vehicle, 5,000,000 welds are performed each day.

Due to the large scale of production (e.g., the number of welds performed per vehicle and the volume of vehicles produced per day), it is impractical to manually inspect every weld on every vehicle. Thus, to ensure the quality of the welds, factory engineers and operators typically perform manual quality control inspections on a very limited sample of welding spots and production vehicles. For example, quality control is traditionally performed using a sampling method, where a random vehicle is selected from the production line each day and various aspects of its production quality are evaluated by factory engineers, such as the weld quality for a representative set of welding spots on the vehicle. This sampling method of quality control is costly and labor intensive, however, and its efficacy is extremely limited, as it leaves many unanswered questions about the production quality of the remaining vehicles that are not inspected each day.

While predictive analytics could potentially be leveraged for quality control and other use cases on the production line, large-scale predictive analytics deployments can be challenging to develop and maintain, particularly with respect to performance and scalability. For example, product manufacturing is typically a complex process that involves a large volume and variety of equipment (e.g., machines, robots, tools) for performing a variety of different tasks using a variety of different materials. As the production process grows in complexity, it becomes more challenging to leverage predictive analytics for quality control and other use cases on the production line. For example, quality control must be performed for all the different machines, tasks, and materials involved in the production process. Training a single predictive analytics model to perform quality control for all machines on the factory floor yields poor performance, however, while training a separate model for each machine becomes impractical or altogether infeasible, particularly as the number of machines grows into the hundreds or even thousands.

Accordingly, in the illustrated embodiment, a predictive analytics model management system 100 is used to facilitate large-scale development, deployment, and maintenance of predictive analytics use cases. In particular, the predictive analytics model management system 100 leverages collaborative filtering to efficiently develop, deploy, and maintain predictive analytics models for large-scale use cases in complex environments. In the illustrated embodiment, for example, predictive analytics is leveraged to perform quality control on the production line, such as detecting faulty production tasks (e.g., faulty welds), detecting faulty components used or produced during production, proactively detecting and/or performing preventive measures that are likely to prevent or minimize faults during production (e.g., configuration changes and/or maintenance tasks), and so forth.

In the illustrated embodiment, for example, each robot uses a tool to perform an assigned task based on specific reference parameters that control how the task is to be performed. Moreover, each time a task is performed, the controller(s) 110a-d of the tool and/or robot generate a data stream with metadata associated with the completed task. For example, the data stream may include a combination of configuration and performance parameters, such as the reference parameters used to configure the robot or tool to perform the task, along with parameters indicating the actual performance of the completed task based on data captured or measured by sensors and other devices.

In some embodiments, for example, the data stream may be represented as a file or data object (e.g., a JSON object) with a collection of values corresponding to the parameters, or “features,” associated with the completed task. The underlying data values in the data stream—which tend to be heavily represented using time-series data—can include any representation of data from any type or combination of modalities, including configuration data for tasks and equipment (e.g., robots, tools), performance data captured by sensors and other devices, visual data—such as images and video—captured by cameras and other visual sensors, audio captured by microphones, and so forth.

As an example, for a spot weld performed by a robot using a welding gun, the data stream may include parameters with the following types of information (among other examples):
(i) the type, thickness, and resistance of the metal being welded;
(ii) the time/date in which the spot weld is performed;
(iii) the location in the factory where the spot weld is performed (e.g., the particular cell 104a-d on the production line);
(iv) the location of the weld on the product being produced (e.g., on a vehicle);
(v) an identifier of the particular robot, robot arm, and welding gun that performed the spot weld;
(vi) maintenance history for the welding gun/controller (e.g., the last time the controller and/or welding gun received maintenance and the type of that maintenance);
(vii) the voltage curve, current curve, force, and torque for the spot weld; and
(viii) the health of the electrodes on the welding gun.

The data streams generated by the controllers 110a-d for the same type of tool will typically have the same information model and streaming format across cells 104a-d, but the characteristics and underlying data values within the data streams will often differ based on the specific tasks assigned to the robots using that tool in each cell 104a-d.

For example, for automobile manufacturing, robots with a welding gun may perform spot welds on different parts of a vehicle in different cells 104a-d. Based on the type and thickness of metal used for the spot welds in different cells 104a-d, the data generated by the welding gun controllers 110a-d may differ considerably and is very dynamic in a tight supply chain automated environment. Similarly, robots with a glue gun may apply glue to different parts of a vehicle in different cells 104a-d, and the data generated by the glue gun controllers 110a-d may differ considerably based on the material of the sheets that are being glued, the glue viscosity, and the ambient temperature and humidity level.

Moreover, the data streams generated by the controllers 110a-d can be ingested and analyzed—at the edge or in the cloud—to train predictive analytics models using machine learning algorithms. For example, data streams from the welding gun controllers 110a-d may be used to train predictive analytics models to detect faulty welds. Training a single predictive analytics model to detect faulty welds for all welding gun controllers on the production line yields poor performance, however, while training a separate model for each welding gun controller is often impractical or even impossible when there are hundreds or even thousands of welding gun controllers.

Thus, in the illustrated embodiment, the predictive analytics model management system 100 leverages the concept of collaborative filtering to strike a balance between training a single generic model for all controllers versus a separate model for each controller.

The concept of collaborative filtering emerged as a breakthrough in recommender systems, where data from a set of users with similar preferences is used to automatically generate custom recommendations for specific users (e.g., based on past product purchases, media consumption habits, ratings/reviews, social media activity, or any other known interests or preferences shared by a group of users). In a more general context, however, collaborative filtering may involve any type of data filtering or pattern recognition that relies on collaboration from multiple sources.

The predictive analytics model management system 100 leverages the concept of collaborative filtering to group data streams based on data characteristics of the different machines or streams, train a predictive analytics model for each group, and classify live data streams using the prediction model corresponding to the group of each stream. In this process, the result is a simplified framework for grouping data and machines in order to scale model development in settings with a large number of streams and/or machines.

In some embodiments, for example, the described solution may include the following features and functionality:
(i) analyzing the data streams to characterize similarities of their underlying data;
(ii) creating groups of streams based on the similarities;
(iii) creating models per group and validating convergence of machine learning models;
(iv) dynamically reconfiguring group(s) based on change in data stream characteristics with appropriate model tuning; and/or
(v) tracking telemetry of adaptive reconfigurations to feed forward learnings for future model development and predictive maintenance of the autonomous agents.

The described solution provides numerous advantages. For example, the described solution uses one model per group instead of per machine. As a result, development and deployment of the models are reduced to the number of unique groups of machines, which makes the model scale manageable. Another benefit derived from model scaling is improved time efficiency of memory-based models. With memory-based models, the training data resides in memory at the time of model inference. The described solution reduces the size of the relevant group datasets, thus allowing the most relevant training data to be loaded into memory. The described solution also provides the ability to dynamically reconfigure group(s) based on changes in data stream characteristics with appropriate model tuning. Moreover, telemetry tracking of adaptive reconfigurations can be used to feed forward learnings for future model development and predictive maintenance of the autonomous agents.

In the illustrated embodiment, for example, the described solution leverages predictive analytics to automate quality control on the production line based on the data streams generated for any task or stage of production, such as welding, riveting, gluing, screwdriving, painting, and so forth. In this manner, quality control can be performed automatically without relying on manual inspections—and with greater accuracy—for 100% of the production tasks and output as opposed to only a very small percentage or sample evaluated through manual inspections. Moreover, while quality control for industrial use cases is discussed as an example, the described solution can be leveraged for any use case involving predictive analytics, machine learning, and/or artificial intelligence.

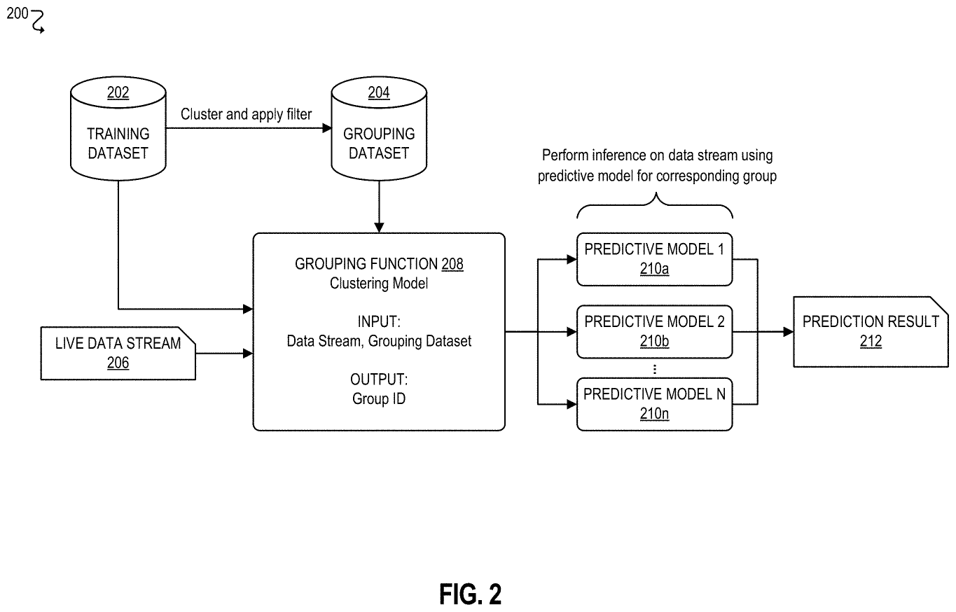

FIG. 2 illustrates an example system architecture 200 for a predictive analytics model management system. In the illustrated example, the predictive analytics model management functionality implemented by system architecture 200 can be summarized as follows:
(i) A machine learning model is used to determine parameters from the training dataset 202 (e.g., a set of labeled data points or data streams) that characterize machine groupings. The machine learning model may be implemented using any suitable data grouping model or clustering model, such as k-means clustering.
(ii) A small set of one or more data points in each group are elected as representatives of that group, and the collection of data points elected across all groups become part of a grouping dataset 204 (or reference dataset). This grouping dataset 204 is configurable and manageable for various ambience/configuration/deployment settings. In some embodiments, for example, such management can be performed via an out-of-band interface communication channel in a Trusted Execution Environment (TEE) (e.g., using TEEs offered on Intel x86 or other computing architectures).
(iii) Using collaborative filtering, each data point ingested from the machine data streams can be classified as belonging to a particular group using an appropriate grouping model 208, such as a distance function or calculation. For example, based on the distance calculation, the group with the shortest distance to a given data point will be assigned as the group for that data point. Similarly, using collaborative filtering, each data point in the existing training dataset 202 can also be classified, which results in group categories. This function of determining a group using an appropriate distance calculation and collaborative filtering is referred to herein as a grouping function 208. Based on the policies/manifests configured, the grouping function 208 can be tuned for efficiency based on past results.
(iv) Predictive analytics models 210a-n can then be developed and deployed per group (e.g., based on the training data points or streams assigned to each group).
(v) Live data streams 206 can then be grouped into the appropriate groups using the grouping function 208, and the corresponding predictive models 210a-n for the assigned groups can then be used to perform inference on the respective data streams 206 to classify and/or generate predictions 212 about them (e.g., quality control predictions).

As an example, the functionality of system architecture 200 will be described in detail with respect to an industrial use case. In this example, consider a factory floor with multiple spot-welding machines. Each spot-welding machine has an associated data stream 206, which publishes (i) the reference parameters that were configured for the machine to operate and (ii) the actual parameters with values set after the application of each spot weld (e.g., based on sensor measurements). Each machine configuration may vary based on many characteristics—for example, the reference parameters may differ when spot welding is applied on metal with different thickness. In this example, the training dataset 202 contains data from multiple streams/machines.

First, a grouping dataset 204 is created from the training dataset 202. For example, characteristics of the training dataset 202 can be used to group machines, and these characteristics can be extracted from the machine configuration by building machine learning models.

In some embodiments, for example, the training dataset 202 is clustered using known clustering algorithms, such as k-means clustering. For example, if it is known that there are only a handful of major configurations applied to a set of machines on a factory floor, a clustering algorithm such as k-means clustering can be applied to group the machines into a particular number of groups corresponding to the number of major configurations. As an example, assuming there are 3-4 major configurations of the machines on the floor, k-means clustering can be used to group the machines into 3-4 different groups by setting k=3 and k=4.

Moreover, the clustering can be refined with even more granularity if other characteristics of the data are known or otherwise determined. For example, with respect to spot welds, the electric current and voltage configurations of welding guns often vary depending on the type of material or metal that is being welded. As a result, the type of metal can be used as a characteristic to cluster the data points in the training dataset and obtain clusters for each metal combination.

The clustering may be performed using a distance calculation 208 that is capable of quantifying the distance between multiple data samples (e.g., the extent to which the samples are different or similar). Depending on the type of features or data available in the data streams, the distance calculation 208 used for clustering/grouping may vary from Euclidean distance or a Jaccard metric (e.g., Jaccard index, similarity coefficient, or distance) for simple sensor data, to dynamic time warping for time-series machine data, among other examples. For example, with respect to spot welding, if the selected feature(s) include the current series applied to a metal combination during each spot weld (e.g., the electric current applied over a period of time), dynamic time warping can be used as the distance calculation since the current series is time-series data.

In this manner, certain data points in the training dataset 202 will form the core of each cluster, and those data points can collectively serve as a grouping dataset 204. In some embodiments, for example, a distance threshold may be used to specify a minimum distance or radius from the center of each cluster that defines the boundary of its respective core. Data points within the core of each cluster can then be elected or filtered based on the distance threshold and then added to the grouping dataset 204.

Each cluster is then assigned an identifier (ID) or group ID. An example of the resulting grouping dataset is shown in Table 1, where the filtered data is grouped by cluster or group ID.

TABLE 1
Grouping Dataset Example

| Group/Cluster ID | Total Power (Feature 1) | STD Current (Feature 2) | . . . |
|---|---|---|---|
| K001 | . . . | . . . | . . . |
| K001 | . . . | . . . | . . . |
| K002 | . . . | . . . | . . . |
| . . . | . . . | . . . | . . . |

The grouping function 208 is a model (recommender system) that implements collaborative filtering with the grouping dataset 204 as its training data. Based on an input data point from a data stream or the existing training dataset, the grouping function 208 recommends a machine group ID that the data point belongs to. Typically, the distance calculation used in the development of the recommender system is the same or similar to the one used to create the grouping dataset 204.

At the model development phase, the grouping function 208 is applied to the existing training dataset 202. For example, the grouping function is used to split the existing training dataset 202 into smaller training datasets or groups based on machine characteristics. The resulting training datasets are then used to train and create machine learning models 210a-n (e.g., predictive models), each of which applies to a specific machine group. For example, each model 210a-n is trained to predict a target variable based on the training dataset 202 for a particular group. The target variable can include any type of predicted information depending on the particular use case that the models 210a-n are developed and trained for (e.g., a predicted quality level for a quality control use case).

In various embodiments, for example, the predictive models may be trained using a variety of different types and combinations of artificial intelligence and/or machine learning, such as logistic regression, random forest, decision trees, classification and regression trees (CART), gradient boosting (e.g., extreme gradient boosted trees), k-nearest neighbors (kNN), Naïve-Bayes, support vector machines (SVM), deep learning (e.g., convolutional neural networks), and/or ensembles thereof (e.g., models that combine the predictions of multiple machine learning models to improve prediction accuracy), among other examples.

At the deployment phase, the resulting models 210a-n are then deployed and used to perform inference or classification on live data streams to generate predictions 212 associated with those data streams (e.g., based on whatever type of prediction or use case the models were trained for). For example, the grouping function 208 is applied to live data streams 206 received from the machines to determine a corresponding group ID for each stream, and based on their group ID, the underlying data point(s) in each stream 206 are then routed to the appropriate model 210a-n to perform the prediction.

The grouping function 208 is a recommender model that first takes the existing training dataset 202 as input and recommends a corresponding group ID for each data point in the training dataset 202. This is achieved by calculating the distance of the current data point in consideration from data points in the grouping dataset 204, and a group ID for the current data point is then selected or assigned based on the distance calculations. In some embodiments, for example, the current data point may be assigned with the group ID corresponding to the closest data point in the grouping dataset 204 (e.g., the data point in the grouping dataset with the smallest distance to the current data point).

In some cases, however, there may be more than one possible group ID for a given data point. These ambiguities can be resolved by retraining the recommender system in such instances, or by creating a selection mechanism to determine which group ID should be favored based on other features, among other examples.

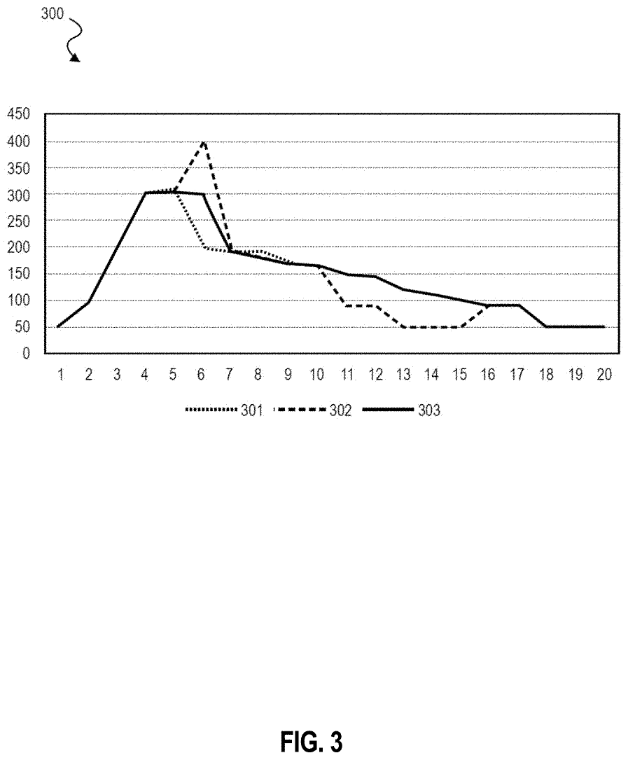

In a product manufacturing use case, for example, current series and metal thickness may be used as the primary features that characterize the machines. Accordingly, the recommender model or data grouping model can be built using dynamic time warping as the distance calculation and the grouping dataset as its training data. The data points from the existing training dataset are applied to the recommender/grouping model to determine the group IDs for those data points. An example of the data grouping process is illustrated and described below in connection with FIG. 3.

The described system architecture 200 is highly scalable. For example, when new machines (both homogenous and heterogenous configurations) are added to the project scope, or when existing machines exhibit changes in their operating conditions, the system can be scaled as follows:
(i) The data stream 206 of the new machine(s) can simply be passed directly as input to the grouping function 208, particularly if it is known that the new machine configurations match those already present in the grouping dataset 204. No redeployments are needed in this scenario.
(ii) If it is determined that the data points of the new machines are not close to any of the data points in the grouping dataset 204, then a new machine group needs to be created. For example, the grouping dataset 204 can be updated by updating the clustering model used to create the grouping dataset 204 to add the new machine group. This requires the grouping model/function 208 to be redeployed since it depends on the grouping dataset 204. The new group ID and corresponding data points are added to the grouping dataset 204, and a new predictive analytics model 210 is created for that group (e.g., developed/trained) and then deployed with the existing predictive analytics models 210.
(iii) In other cases, when an existing machine's data stream 206 subsequently matches another group ID more closely than its original group ID, the solution allows rescoping, post validation of the rationale behind the change in data stream behavior (e.g., age, ambience conditions, and so forth). In addition, in extreme cases where there is major scope change, the models used for the grouping dataset 204 and the grouping function 208 may need to be reevaluated.

The described system architecture 200 also supports centralized or de-centralized systems to track telemetry of the group management for synchronization, calibration, record keeping, audit, and future enhancements, among other examples.

Moreover, in some embodiments, if a group of machines assigned to the same group ID becomes inactive and stops generating data streams (e.g., the machines are temporarily powered off or otherwise become idle), the corresponding predictive model 210a-n for that group may be deactivated to free compute resources (e.g., processing/memory resources) until those machines become active again, at which time the predictive model 210a-n may be reactivated.

FIG. 3 illustrates a current series graph 300 for an example of grouping data streams for predictive analytics model management. In the illustrated example, graph 300 illustrates current series 301, 302, and 303, which correspond to electric currents represented in three different data streams. In some embodiments, for example, the current series within a particular data stream may contain time-series data that represents the electric current measured during a particular instance of a task, such as the electric current measured during each of three different spot welds represented by three different data streams.

To illustrate the concept of grouping, assume that current series 301 and 302 are from data streams/points in the grouping dataset, while current series 303 is from a data stream/point in the training dataset that has not yet been grouped. In order to determine the appropriate group for current series 303, a distance calculation is used to compare the distance of current series 303 from current series 301 and current series 302, respectively. As depicted in graph 300, the distance between current series 303 and 301 is smaller than the distance between current series 303 and 302 (e.g., current series 303 is more similar to current series 301 than current series 302). As a result, current series 303 may be assigned to the same group as current series 301, which may be represented by a particular group identifier (ID).

The groups and group IDs for all other data streams/points in the training dataset are determined in a similar manner, and the original training dataset is then split into separate training datasets that are made available per machine group (e.g., per-group subsets of the original training dataset). A predictive analytics model is then developed and trained per machine group based on the corresponding training dataset for each group. As an example, predictive analytics models for the respective groups could be trained based on certain features represented in the respective training datasets for an industrial use case, such as predicting or determining the quality of spot welds (e.g., good vs. defective/errored) based on certain features or characteristics represented in the data streams generated for the spot welds.

The resulting predictive analytics models for the various groups are then deployed, and live data streams are then grouped and classified using the appropriate predictive analytics models. For example, a group ID may be determined for a live data stream using the same or similar grouping function applied to the training dataset during the training process, and the predictive analytics model corresponding to that group ID may then be used to perform inference or classification on the live data stream. As an example, a live data stream generated by a welding gun controller for a spot weld may be grouped and then classified using the appropriate predictive analytics model for that group to predict the quality of the spot weld.

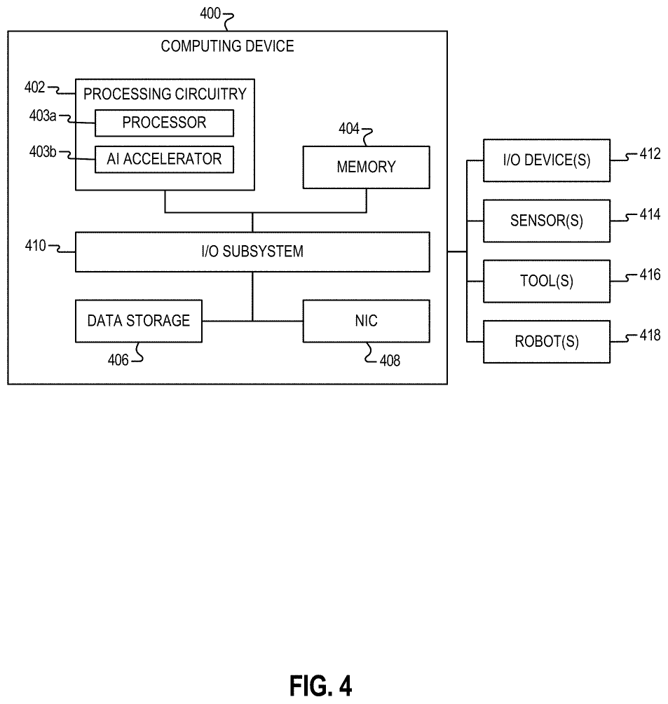

FIG. 4 illustrates an example of a computing device 400 for predictive analytics model management in accordance with certain embodiments. In some embodiments, for example, computing device 400 may be used to implement the predictive analytics model management functionality described throughout this disclosure.

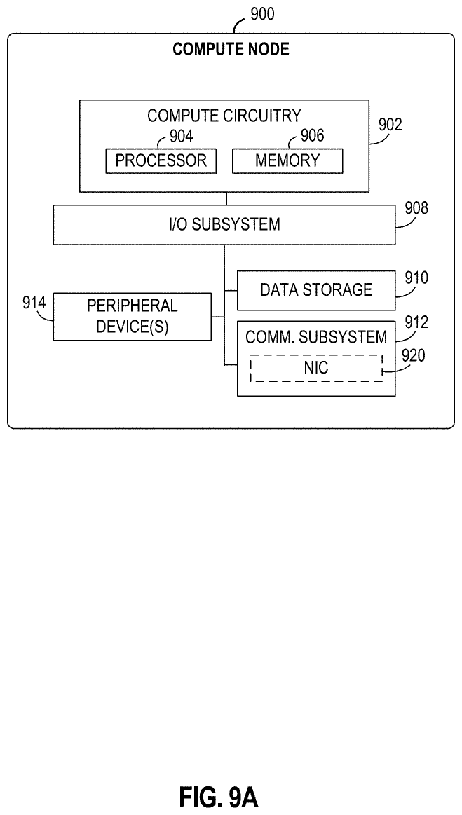

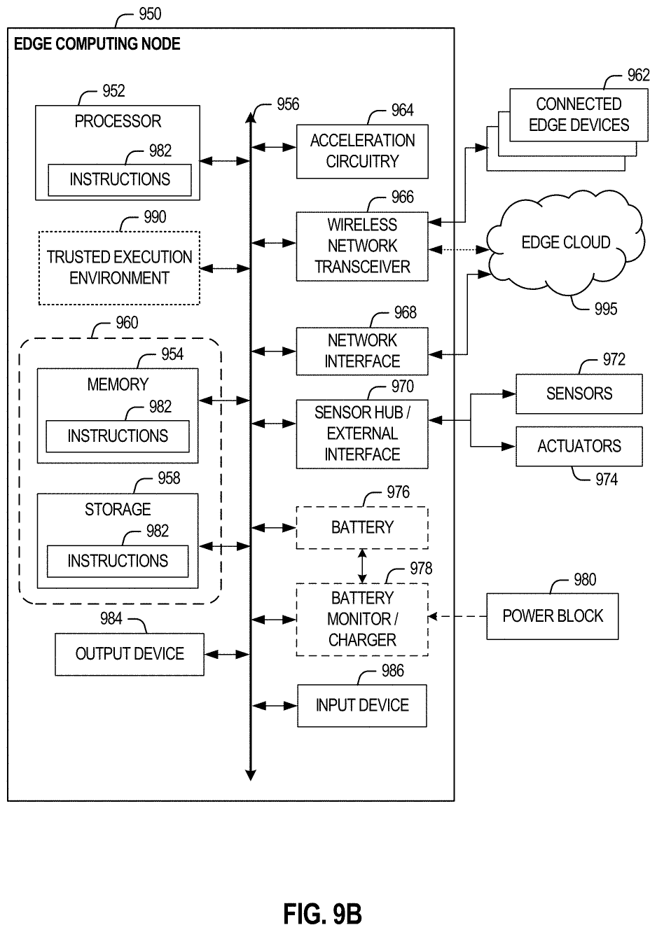

In the illustrated embodiment, computing device 400 includes processing circuitry 402, memory 404, data storage device 406, network interface controller (NIC) 408, and input/output (I/O) subsystem 410. The processing circuitry 402 includes a collection of processing components 403, such as a processor 403a (e.g., central processing unit (CPU), microcontroller, etc.) and an artificial intelligence (Al) accelerator 403b (e.g., co-processor, ASIC, FPGA, etc.). The computing device 400 is also coupled to various other devices (e.g., via I/O subsystem 410 and/or NIC 408), such as I/O device(s) 412 (e.g., display/touchscreen, keyboard, mouse, etc.), sensor(s) 414 (e.g., voltage/current sensors, temperature/thermal sensors, humidity sensors, pressure sensors, camera sensors, audio sensors, infrared (IR) sensors, accelerometers, etc.), tool(s) 416 (e.g., welding gun, glue gun, riveting machine, screwdriver, pump, etc.), and/or robot(s) 418. In some embodiments, certain components of computing device 400 may be similar to those shown and described in connection with the computing devices of FIGS. 9A-B.

Further, computing device 400 may be used to implement any or all aspects of the predictive analytics model management functionality described throughout this disclosure. In some embodiments, for example, computing device 400 may receive data streams generated by tools 416 and/or robots 418 (and/or their associated sensors 414), group the data streams into data stream groups, and perform predictive analytics on the data streams using predictive models trained for the respective data stream groups.

In some embodiments, computing device 400 may be implemented as a standalone device that interfaces or communicates with the I/O devices 412, sensors 414, tools 416, and/or robots 418. Alternatively, or additionally, computing device 400 may be integrated with, or embedded as part of, one or more of the I/O devices 412, sensors 414, tools 416, and/or robots 418. Further, in some embodiments, the functionality of computing device 400 may be implemented or distributed across multiple devices (e.g., multiple servers, computing devices, controllers, tools, robots, etc.).

In some embodiments, for example, computing device 400 may be an edge server used to perform predictive analytics on the data streams generated by the tools 416 and/or robots 418 (and/or their associated sensors 414). Additionally, or alternatively, computing device 400 may be a tool or robot controller used to control one or more tools 416 and/or robots 418 and perform predictive analytics on their corresponding data streams. For example, computing device 400 may be a controller embedded within a particular tool 416 or robot 418, or computing device 400 may be an external controller used to control one or more tools 416 and/or robots 418.

Moreover, the tools 416 and/or robots 418 can include any type of tools, robots, machines, equipment, or other suitable devices depending on the particular use case. For example, the tools 416 may include welding guns, glue guns, riveting machines, screwdrivers, pumps, and/or other types of tools, machines, or equipment. Moreover, the robots 418 may include any devices, machines, and/or equipment for automating and/or aiding in the performance of certain tasks, including articulated robots, cartesian robots, cylindrical robots, polar/spherical robots, SCARA robots, delta robots, and humanoids, among other examples.

Articulated robots—which are also referred to as robotic arms or manipulator arms—are robots with rotary joints that resemble a human arm. For example, an articulated robot typically includes an arm with multiple links connected by rotary joints, which is attached to a base via a twisting joint. Each joint is an axis that provides an additional degree of freedom or range of motion, and each robot often includes four to six axes.

Cartesian coordinate robots—which are also referred to as rectilinear, gantry robots, and x-y-z robots—are designed for linear movement based on the Cartesian coordinate system (X, Y, and Z). For example, a cartesian robot typically includes three prismatic joints for linear movement along an X, Y, and Z axis, and may further include an attached wrist for rotational movement, such as three rotary joints to adjust its orientation in space.

Cylindrical coordinate robots include at least one rotary joint at the base and at least one prismatic joint to connect its links. The rotary joint provides rotational motion along the joint axis, while the prismatic joint provides linear motion. In this manner, cylindrical robots can move vertically and horizontally by sliding.

Polar robots—which are also referred to as spherical coordinate robots—typically include an arm connected to a base with a twisting joint, along with two rotary joints and one linear joint, forming a polar coordinate system.

SCARA robots (Selective Compliance Assembly Robot Arm) include two parallel joints for movement in the X-Y plane and are typically used for assembly applications that require precise lateral movements.

Delta robots—which are also referred to as parallel link robots—are spider-like robots with jointed parallelograms (e.g., parallel links) connected to a common base. Delta robots are often used for tasks that require precise movement and/or maneuvering.

Humanoids are robots that resemble a human, such as a robot that includes a body, arms, legs, and optionally a head.

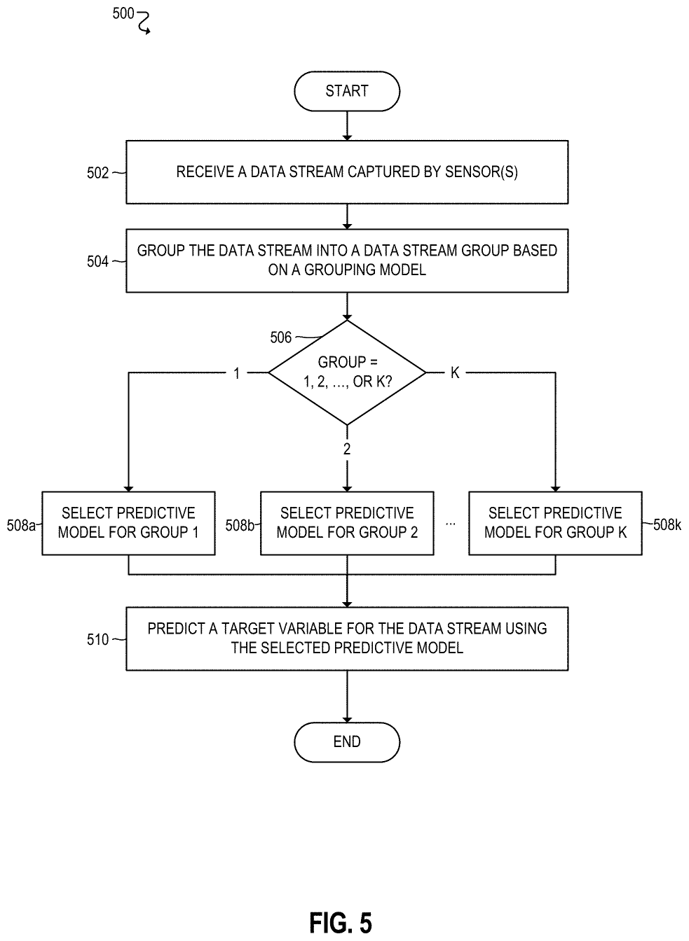

FIG. 5 illustrates a flowchart 500 for an example embodiment of predictive analytics model management. In some embodiments, flowchart 500 may be implemented and/or performed using the computing systems, devices, and networks described throughout this disclosure. In some embodiments, for example, the computing device may be an edge server (e.g., a physical box or housing containing hardware/software components for implementing the invention), a tool controller, a robot controller, and so forth.

The flowchart begins at block 502, where a data stream captured at least partially by one or more sensors is received. For example, the data stream may include a set of feature values corresponding to an unlabeled instance of a feature set. A feature set may refer to a group of features that a machine learning model uses for training and inference, such as a collection of properties, characteristics, or attributes associated with some type of observation (e.g., observations about objects or actions in the physical world). Moreover, the feature values for an instance of the feature set may refer to the values of the features for a particular instance of that observation (e.g., values of the features for a specific object or action in the physical world). In some embodiments, a feature vector may be used to represent the feature values for the features in the feature set. Further, in various embodiments, for example, some or all of the feature values may be captured by or obtained from sensors and other devices.

As an example, in a product manufacturing use case, the feature set may include features corresponding to various properties, characteristics, or attributes associated with a particular type of task or operation performed on the production line during product manufacturing (e.g., welding, gluing, screwdriving, riveting). Moreover, each time the task is performed on the production line, feature values for that instance of the task may be obtained or collected from a variety of sources, such as sensors, controllers, computing devices, and other equipment on the production line (e.g., tools, robots, machines).

The flowchart then proceeds to block 504 to group the data stream into a data stream group. For example, a grouping model may be used to assign a data stream group to the data stream from a set of data stream groups based on the set of feature values in the data stream.

In some embodiments, for example, the grouping model may represent or indicate a set of data stream groups that are assigned to a set of grouping data streams in a grouping dataset. For example, the grouping dataset may include a set of representative data streams for each data stream group in the set of data stream groups. In some embodiments, the set of representative data streams for each data stream group may be selected from a training dataset (e.g., a set of training data streams), and the grouping dataset may be generated to include the set of representative data streams selected for each data stream group.

In some embodiments, for example, the grouping model may be a clustering model, such as a k-means clustering model. Moreover, the data stream group assigned to the incoming data stream may be selected from the set of data stream groups based on the group assignments in the grouping model. For example, the grouping model may select the data stream group from the set of data stream groups based on a comparison of the data stream to the representative streams for each group in the grouping dataset.

In some embodiments, a distance calculation may be used to compute a distance to the data stream from each data stream group in the set of data stream groups, and the group whose distance to the data stream is the smallest or closest may be selected from the set of data stream groups and assigned to the data stream. For example, the distance calculation may be used to compute the distance from the data stream to each data stream group based on the set of representative data streams in each data stream group.

The distance calculation can be implemented using any suitable function for computing a distance between multiple data samples—such as a Euclidean distance calculation, a Jaccard calculation, or a dynamic time warping calculation—which may vary depending on the type of data used to represent the feature values in the data streams.

In some cases, the characteristics of a data stream may change after the data stream has already been assigned to a data stream group. Thus, in some embodiments, the groupings may be dynamically updated to adapt to changes in data stream characteristics. For example, if a change is detected in the set of feature values in a data stream, it may be determined whether the grouping of the data stream should be updated based on the change. In particular, the distance calculation may reveal that the data stream is now closer to another data stream group, or that the data stream is not close to any of the existing data stream groups and thus a new group should be created. Thus, the set of data stream groups may be dynamically updated to reassign the data stream to another data stream group in the set of data stream groups (e.g., an existing group or a newly created group).

The flowchart then proceeds to block 506 to determine which data stream group the data stream was assigned to (e.g., group 1, 2, . . . , k), and then to one of blocks 508a-k to select the predictive analytics model corresponding to that data stream group. In particular, the predictive model may be selected from a set of predictive models that have been trained to predict a target variable for the set of data stream groups, where each predictive model has been trained to predict the target variable for a particular data stream group based on the training data streams assigned to that group.

In some embodiments, for example, the predictive models may have been trained based on a training dataset prior to receiving the live data stream that is currently being processed (e.g., training performed offline rather than in real time). For example, the training dataset may include a set of training data streams, each of which contains feature values for the feature set and a ground truth label for a target variable (e.g., a ground truth quality level for a manufacturing task represented by the feature values in the data streams). Moreover, the training data streams in the training dataset may be grouped or assigned to the set of data stream groups using the grouping model/function described above. Predictive models are then trained to predict the target variable for each data stream group based on the training data streams assigned to the respective data stream groups. For example, each predictive model may be trained to predict the target variable for a corresponding data stream group based on a corresponding subset of training data streams assigned to that group from the training dataset.

As an example, in a product manufacturing use case, the target variable may include a predicted quality level for a manufacturing task performed by a machine (e.g., a tool or robot) in order to manufacture a product, such as the quality level of a spot weld performed for automobile manufacturing.

Thus, in order to predict the target variable for the incoming or live data stream, the predictive model for the data stream group assigned to the live data stream is selected from the set of predictive models.

The flowchart then proceeds to block 510 to predict the target variable for the data stream using the selected predictive model (e.g., by performing inference using the predictive model to infer the target variable based on the set of feature values in the data stream). In some embodiments, for example, the set of feature values in the data stream is supplied as input to the selected predictive model, and the predictive model then analyzes those feature values and generates an output, which may contain a prediction of—or may otherwise be used to predict—the target variable corresponding to the data stream (e.g., a predicted quality level of a manufacturing task or component).

At this point, the flowchart may be complete. In some embodiments, however, the flowchart may restart and/or certain blocks may be repeated. For example, in some embodiments, the flowchart may restart at block 502 to continue receiving data streams and performing predictive analytics on the data streams.

Example Computing Embodiments

The following sections present examples of computing devices, platforms, systems, architectures, and environments that may be used to implement the predictive analytics solution described throughout this disclosure.

Edge Computing Embodiments

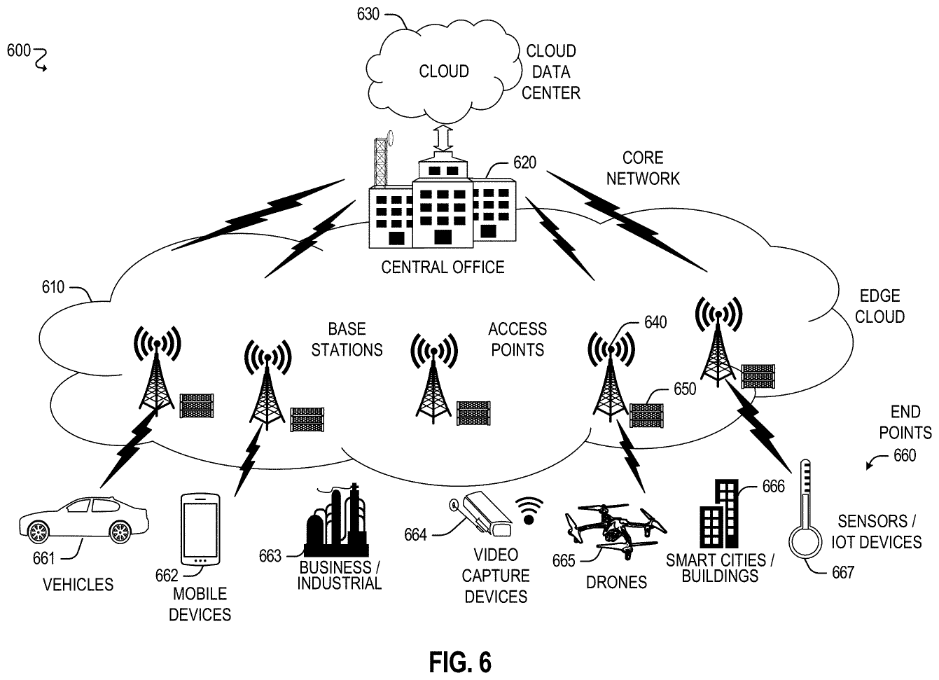

FIG. 6 is a block diagram 600 showing an overview of a configuration for edge computing, which includes a layer of processing referred to in many of the following examples as an “edge cloud”. As shown, the edge cloud 610 is co-located at an edge location, such as an access point or base station 640, a local processing hub 650, or a central office 620, and thus may include multiple entities, devices, and equipment instances. The edge cloud 610 is located much closer to the endpoint (consumer and producer) data sources 660 (e.g., autonomous vehicles 661, user equipment 662, business and industrial equipment 663, video capture devices 664, drones 665, smart cities and building devices 666, sensors and IoT devices 667, etc.) than the cloud data center 630. Compute, memory, and storage resources which are offered at the edges in the edge cloud 610 are critical to providing ultra-low latency response times for services and functions used by the endpoint data sources 660 as well as reduce network backhaul traffic from the edge cloud 610 toward cloud data center 630 thus improving energy consumption and overall network usages among other benefits.

Compute, memory, and storage are scarce resources, and generally decrease depending on the edge location (e.g., fewer processing resources being available at consumer endpoint devices, than at a base station, than at a central office). However, the closer that the edge location is to the endpoint (e.g., user equipment (UE)), the more that space and power is often constrained. Thus, edge computing attempts to reduce the amount of resources needed for network services, through the distribution of more resources which are located closer both geographically and in network access time. In this manner, edge computing attempts to bring the compute resources to the workload data where appropriate, or, bring the workload data to the compute resources.

The following describes aspects of an edge cloud architecture that covers multiple potential deployments and addresses restrictions that some network operators or service providers may have in their own infrastructures. These include, variation of configurations based on the edge location (because edges at a base station level, for instance, may have more constrained performance and capabilities in a multi-tenant scenario); configurations based on the type of compute, memory, storage, fabric, acceleration, or like resources available to edge locations, tiers of locations, or groups of locations; the service, security, and management and orchestration capabilities; and related objectives to achieve usability and performance of end services. These deployments may accomplish processing in network layers that may be considered as “near edge”, “close edge”, “local edge”, “middle edge”, or “far edge” layers, depending on latency, distance, and timing characteristics.

Edge computing is a developing paradigm where computing is performed at or closer to the “edge” of a network, typically through the use of a compute platform (e.g., x86 or ARM compute hardware architecture) implemented at base stations, gateways, network routers, or other devices which are much closer to endpoint devices producing and consuming the data. For example, edge gateway servers may be equipped with pools of memory and storage resources to perform computation in real-time for low latency use-cases (e.g., autonomous driving or video surveillance) for connected client devices. Or as an example, base stations may be augmented with compute and acceleration resources to directly process service workloads for connected user equipment, without further communicating data via backhaul networks. Or as another example, central office network management hardware may be replaced with standardized compute hardware that performs virtualized network functions and offers compute resources for the execution of services and consumer functions for connected devices. Within edge computing networks, there may be scenarios in services which the compute resource will be “moved” to the data, as well as scenarios in which the data will be “moved” to the compute resource. Or as an example, base station compute, acceleration and network resources can provide services in order to scale to workload demands on an as needed basis by activating dormant capacity (subscription, capacity on demand) in order to manage corner cases, emergencies or to provide longevity for deployed resources over a significantly longer implemented lifecycle.

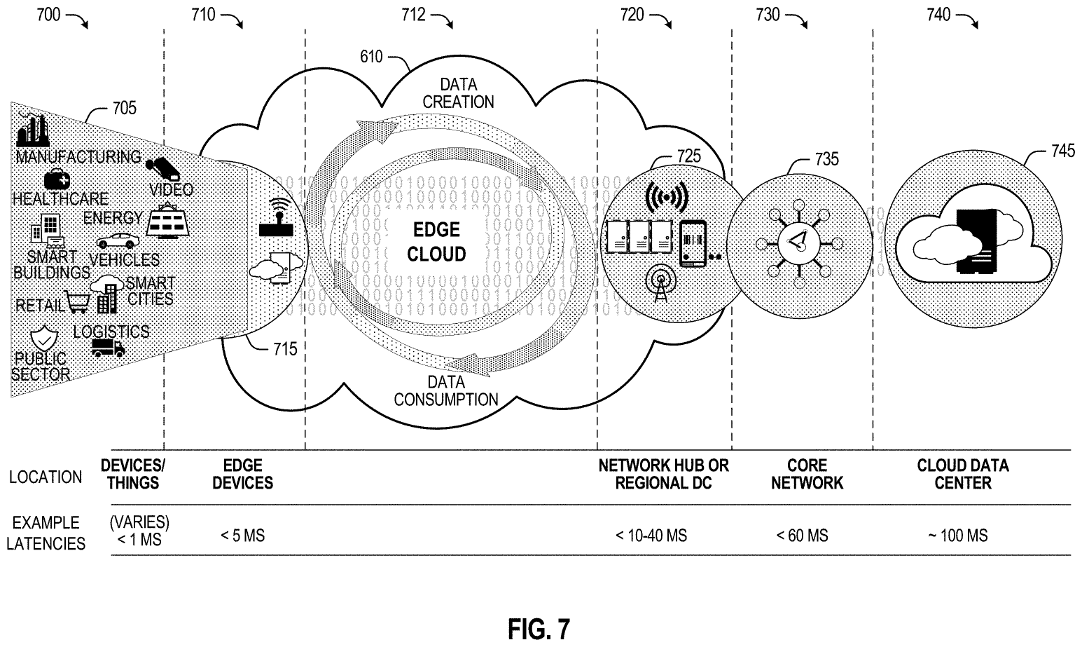

FIG. 7 illustrates operational layers among endpoints, an edge cloud, and cloud computing environments. Specifically, FIG. 7 depicts examples of computational use cases 705, utilizing the edge cloud 610 among multiple illustrative layers of network computing. The layers begin at an endpoint (devices and things) layer 700, which accesses the edge cloud 610 to conduct data creation, analysis, and data consumption activities. The edge cloud 610 may span multiple network layers, such as an edge devices layer 710 having gateways, on-premise servers, or network equipment (nodes 715) located in physically proximate edge systems; a network access layer 720, encompassing base stations, radio processing units, network hubs, regional data centers (DC), or local network equipment (equipment 725); and any equipment, devices, or nodes located therebetween (in layer 712, not illustrated in detail). The network communications within the edge cloud 610 and among the various layers may occur via any number of wired or wireless mediums, including via connectivity architectures and technologies not depicted.

Examples of latency, resulting from network communication distance and processing time constraints, may range from less than a millisecond (ms) when among the endpoint layer 700, under 5 ms at the edge devices layer 710, to even between 10 to 40 ms when communicating with nodes at the network access layer 720. Beyond the edge cloud 610 are core network 730 and cloud data center 740 layers, each with increasing latency (e.g., between 50-60 ms at the core network layer 730, to 100 or more ms at the cloud data center layer). As a result, operations at a core network data center 735 or a cloud data center 745, with latencies of at least 50 to 100 ms or more, will not be able to accomplish many time-critical functions of the use cases 705. Each of these latency values are provided for purposes of illustration and contrast; it will be understood that the use of other access network mediums and technologies may further reduce the latencies. In some examples, respective portions of the network may be categorized as “close edge”, “local edge”, “near edge”, “middle edge”, or “far edge” layers, relative to a network source and destination. For instance, from the perspective of the core network data center 735 or a cloud data center 745, a central office or content data network may be considered as being located within a “near edge” layer (“near” to the cloud, having high latency values when communicating with the devices and endpoints of the use cases 705), whereas an access point, base station, on-premise server, or network gateway may be considered as located within a “far edge” layer (“far” from the cloud, having low latency values when communicating with the devices and endpoints of the use cases 705). It will be understood that other categorizations of a particular network layer as constituting a “close”, “local”, “near”, “middle”, or “far” edge may be based on latency, distance, number of network hops, or other measurable characteristics, as measured from a source in any of the network layers 700-740.

The various use cases 705 may access resources under usage pressure from incoming streams, due to multiple services utilizing the edge cloud. To achieve results with low latency, the services executed within the edge cloud 610 balance varying requirements in terms of: (a) Priority (throughput or latency) and Quality of Service (QoS) (e.g., traffic for an autonomous car may have higher priority than a temperature sensor in terms of response time requirement; or, a performance sensitivity/bottleneck may exist at a compute/accelerator, memory, storage, or network resource, depending on the application); (b) Reliability and Resiliency (e.g., some input streams need to be acted upon and the traffic routed with mission-critical reliability, where as some other input streams may be tolerate an occasional failure, depending on the application); and (c) Physical constraints (e.g., power, cooling and form-factor).

The end-to-end service view for these use cases involves the concept of a service-flow and is associated with a transaction. The transaction details the overall service requirement for the entity consuming the service, as well as the associated services for the resources, workloads, workflows, and business functional and business level requirements. The services executed with the “terms” described may be managed at each layer in a way to assure real time, and runtime contractual compliance for the transaction during the lifecycle of the service. When a component in the transaction is missing its agreed to SLA, the system as a whole (components in the transaction) may provide the ability to (1) understand the impact of the SLA violation, and (2) augment other components in the system to resume overall transaction SLA, and (3) implement steps to remediate.

Thus, with these variations and service features in mind, edge computing within the edge cloud 610 may provide the ability to serve and respond to multiple applications of the use cases 705 (e.g., object tracking, video surveillance, connected cars, etc.) in real-time or near real-time, and meet ultra-low latency requirements for these multiple applications. These advantages enable a whole new class of applications (Virtual Network Functions (VNFs), Function as a Service (FaaS), Edge as a Service (EaaS), standard processes, etc.), which cannot leverage conventional cloud computing due to latency or other limitations.

However, with the advantages of edge computing comes the following caveats. The devices located at the edge are often resource constrained and therefore there is pressure on usage of edge resources. Typically, this is addressed through the pooling of memory and storage resources for use by multiple users (tenants) and devices. The edge may be power and cooling constrained and therefore the power usage needs to be accounted for by the applications that are consuming the most power. There may be inherent power-performance tradeoffs in these pooled memory resources, as many of them are likely to use emerging memory technologies, where more power requires greater memory bandwidth. Likewise, improved security of hardware and root of trust trusted functions are also required, because edge locations may be unmanned and may even need permissioned access (e.g., when housed in a third-party location). Such issues are magnified in the edge cloud 610 in a multi-tenant, multi-owner, or multi-access setting, where services and applications are requested by many users, especially as network usage dynamically fluctuates and the composition of the multiple stakeholders, use cases, and services changes.

At a more generic level, an edge computing system may be described to encompass any number of deployments at the previously discussed layers operating in the edge cloud 610 (network layers 700-740), which provide coordination from client and distributed computing devices. One or more edge gateway nodes, one or more edge aggregation nodes, and one or more core data centers may be distributed across layers of the network to provide an implementation of the edge computing system by or on behalf of a telecommunication service provider (“telco”, or “TSP”), internet-of-things service provider, cloud service provider (CSP), enterprise entity, or any other number of entities. Various implementations and configurations of the edge computing system may be provided dynamically, such as when orchestrated to meet service objectives.

Consistent with the examples provided herein, a client compute node may be embodied as any type of endpoint component, device, appliance, or other thing capable of communicating as a producer or consumer of data. Further, the label “node” or “device” as used in the edge computing system does not necessarily mean that such node or device operates in a client or agent/minion/follower role; rather, any of the nodes or devices in the edge computing system refer to individual entities, nodes, or subsystems which include discrete or connected hardware or software configurations to facilitate or use the edge cloud 610.

As such, the edge cloud 610 is formed from network components and functional features operated by and within edge gateway nodes, edge aggregation nodes, or other edge compute nodes among network layers 710-730. The edge cloud 610 thus may be embodied as any type of network that provides edge computing and/or storage resources which are proximately located to radio access network (RAN) capable endpoint devices (e.g., mobile computing devices, IoT devices, smart devices, etc.), which are discussed herein. In other words, the edge cloud 610 may be envisioned as an “edge” which connects the endpoint devices and traditional network access points that serve as an ingress point into service provider core networks, including mobile carrier networks (e.g., Global System for Mobile Communications (GSM) networks, Long-Term Evolution (LTE) networks, 5G/6G networks, etc.), while also providing storage and/or compute capabilities. Other types and forms of network access (e.g., Wi-Fi, long-range wireless, wired networks including optical networks) may also be utilized in place of or in combination with such 3GPP carrier networks.

The network components of the edge cloud 610 may be servers, multi-tenant servers, appliance computing devices, and/or any other type of computing devices. For example, the edge cloud 610 may include an appliance computing device that is a self-contained electronic device including a housing, a chassis, a case or a shell. In some circumstances, the housing may be dimensioned for portability such that it can be carried by a human and/or shipped. Example housings may include materials that form one or more exterior surfaces that partially or fully protect contents of the appliance, in which protection may include weather protection, hazardous environment protection (e.g., EMI, vibration, extreme temperatures), and/or enable submergibility. Example housings may include power circuitry to provide power for stationary and/or portable implementations, such as AC power inputs, DC power inputs, AC/DC or DC/AC converter(s), power regulators, transformers, charging circuitry, batteries, wired inputs and/or wireless power inputs. Example housings and/or surfaces thereof may include or connect to mounting hardware to enable attachment to structures such as buildings, telecommunication structures (e.g., poles, antenna structures, etc.) and/or racks (e.g., server racks, blade mounts, etc.). Example housings and/or surfaces thereof may support one or more sensors (e.g., temperature sensors, vibration sensors, light sensors, acoustic sensors, capacitive sensors, proximity sensors, etc.). One or more such sensors may be contained in, carried by, or otherwise embedded in the surface and/or mounted to the surface of the appliance. Example housings and/or surfaces thereof may support mechanical connectivity, such as propulsion hardware (e.g., wheels, propellers, etc.) and/or articulating hardware (e.g., robot arms, pivotable appendages, etc.). In some circumstances, the sensors may include any type of input devices such as user interface hardware (e.g., buttons, switches, dials, sliders, etc.). In some circumstances, example housings include output devices contained in, carried by, embedded therein and/or attached thereto. Output devices may include displays, touchscreens, lights, LEDs, speakers, I/O ports (e.g., USB), etc. In some circumstances, edge devices are devices presented in the network for a specific purpose (e.g., a traffic light), but may have processing and/or other capacities that may be utilized for other purposes. Such edge devices may be independent from other networked devices and may be provided with a housing having a form factor suitable for its primary purpose; yet be available for other compute tasks that do not interfere with its primary task. Edge devices include Internet of Things devices. The appliance computing device may include hardware and software components to manage local issues such as device temperature, vibration, resource utilization, updates, power issues, physical and network security, etc. Example hardware for implementing an appliance computing device is described in conjunction with FIG. 9B. The edge cloud 610 may also include one or more servers and/or one or more multi-tenant servers. Such a server may include an operating system and implement a virtual computing environment. A virtual computing environment may include a hypervisor managing (e.g., spawning, deploying, destroying, etc.) one or more virtual machines, one or more containers, etc. Such virtual computing environments provide an execution environment in which one or more applications and/or other software, code or scripts may execute while being isolated from one or more other applications, software, code or scripts.

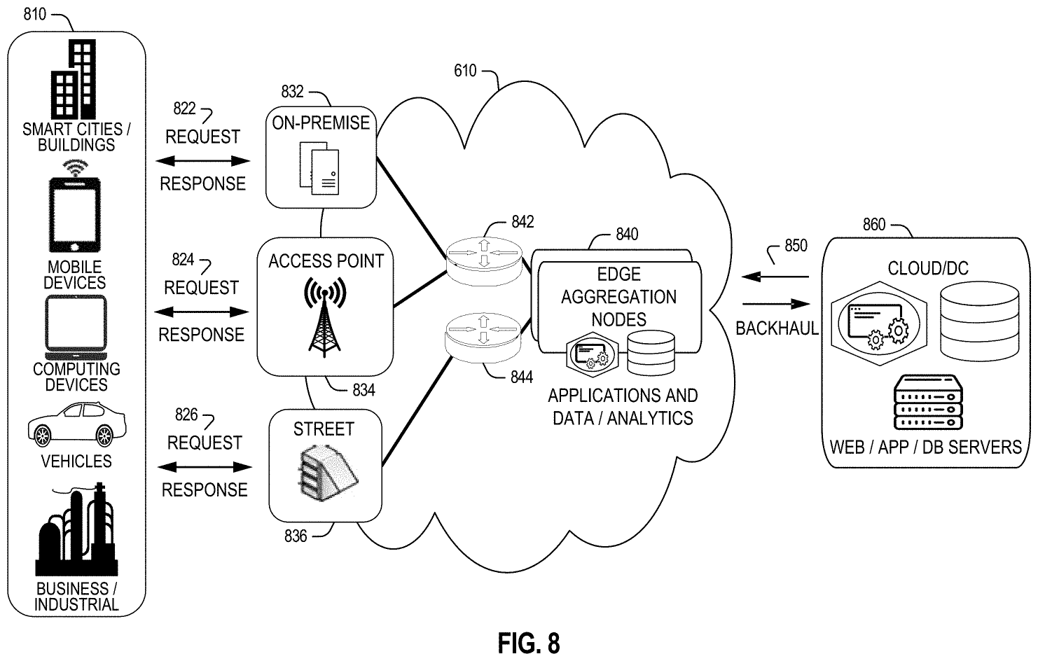

In FIG. 8, various client endpoints 810 (in the form of mobile devices, computers, autonomous vehicles, business computing equipment, industrial processing equipment) exchange requests and responses that are specific to the type of endpoint network aggregation. For instance, client endpoints 810 may obtain network access via a wired broadband network, by exchanging requests and responses 822 through an on-premise network system 832. Some client endpoints 810, such as mobile computing devices, may obtain network access via a wireless broadband network, by exchanging requests and responses 824 through an access point (e.g., cellular network tower) 834. Some client endpoints 810, such as autonomous vehicles may obtain network access for requests and responses 826 via a wireless vehicular network through a street-located network system 836. However, regardless of the type of network access, the TSP may deploy aggregation points 842, 844 within the edge cloud 610 to aggregate traffic and requests. Thus, within the edge cloud 610, the TSP may deploy various compute and storage resources, such as at edge aggregation nodes 840, to provide requested content. The edge aggregation nodes 840 and other systems of the edge cloud 610 are connected to a cloud or data center 860, which uses a backhaul network 850 to fulfill higher-latency requests from a cloud/data center for websites, applications, database servers, etc. Additional or consolidated instances of the edge aggregation nodes 840 and the aggregation points 842, 844, including those deployed on a single server framework, may also be present within the edge cloud 610 or other areas of the TSP infrastructure.

Computing Nodes, Devices, Platforms, and Systems

FIGS. 9A-B illustrate example embodiments of compute devices. In various embodiments, any of the compute nodes or devices discussed throughout this disclosure may be fulfilled based on the components depicted in FIGS. 9A-B. For example, respective edge compute nodes may be embodied as a type of device, appliance, computer, or other “thing” capable of communicating with other edge, networking, or endpoint components. For example, an edge compute device may be embodied as a smartphone, a mobile compute device, a smart appliance, an in-vehicle compute system (e.g., a navigation system), an edge or on-premise server, equipment, tool, robot, or other device or system capable of performing the described functions.

In the simplified example depicted in FIG. 9A, an edge compute node 900 includes a compute engine (also referred to herein as “compute circuitry”) 902, an input/output (I/O) subsystem 908, data storage 910, a communication circuitry subsystem 912, and, optionally, one or more peripheral devices 914. In other examples, respective compute devices may include other or additional components, such as those typically found in a computer (e.g., a display, peripheral devices, etc.). Additionally, in some examples, one or more of the illustrative components may be incorporated in, or otherwise form a portion of, another component.

The compute node 900 may be embodied as any type of engine, device, or collection of devices capable of performing various compute functions. In some examples, the compute node 900 may be embodied as a single device such as an integrated circuit, an embedded system, a field-programmable gate array (FPGA), a system-on-a-chip (SOC), or other integrated system or device. In the illustrative example, the compute node 900 includes or is embodied as a processor 904 and a memory 906. The processor 904 may be embodied as any type of processor capable of performing the functions described herein (e.g., executing an application). For example, the processor 904 may be embodied as a multi-core processor(s), a microcontroller, a processing unit, a specialized or special purpose processing unit, or other processor or processing/controlling circuit.

In some examples, the processor 904 may be embodied as, include, or be coupled to an FPGA, an application specific integrated circuit (ASIC), reconfigurable hardware or hardware circuitry, or other specialized hardware to facilitate performance of the functions described herein. Also in some examples, the processor 704 may be embodied as a specialized x-processing unit (xPU) also known as a data processing unit (DPU), infrastructure processing unit (IPU), or network processing unit (NPU). Such an xPU may be embodied as a standalone circuit or circuit package, integrated within an SOC, or integrated with networking circuitry (e.g., in a SmartNIC, or enhanced SmartNIC), acceleration circuitry, storage devices, or Al hardware (e.g., GPUs or programmed FPGAs). Such an xPU may be designed to receive programming to process one or more data streams and perform specific tasks and actions for the data streams (such as hosting microservices, performing service management or orchestration, organizing or managing server or data center hardware, managing service meshes, or collecting and distributing telemetry), outside of the CPU or general purpose processing hardware. However, it will be understood that a xPU, a SOC, a CPU, and other variations of the processor 904 may work in coordination with each other to execute many types of operations and instructions within and on behalf of the compute node 900.

The memory 906 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. Non-limiting examples of volatile memory may include various types of random access memory (RAM), such as DRAM or static random access memory (SRAM). One particular type of DRAM that may be used in a memory module is synchronous dynamic random access memory (SDRAM).

In an example, the memory device is a block addressable memory device, such as those based on NAND or NOR technologies. A memory device may also include a three dimensional crosspoint memory device (e.g., Intel® 3D XPoint™ memory), or other byte addressable write-in-place nonvolatile memory devices. The memory device may refer to the die itself and/or to a packaged memory product. In some examples, 3D crosspoint memory (e.g., Intel® 3D XPoint™ memory) may comprise a transistor-less stackable cross point architecture in which memory cells sit at the intersection of word lines and bit lines and are individually addressable and in which bit storage is based on a change in bulk resistance. In some examples, all or a portion of the memory 906 may be integrated into the processor 904. The memory 906 may store various software and data used during operation such as one or more applications, data operated on by the application(s), libraries, and drivers.

The compute circuitry 902 is communicatively coupled to other components of the compute node 900 via the I/O subsystem 908, which may be embodied as circuitry and/or components to facilitate input/output operations with the compute circuitry 902 (e.g., with the processor 904 and/or the main memory 906) and other components of the compute circuitry 902. For example, the I/O subsystem 908 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some examples, the I/O subsystem 908 may form a portion of a system-on-a-chip (SoC) and be incorporated, along with one or more of the processor 904, the memory 906, and other components of the compute circuitry 902, into the compute circuitry 902.

The one or more illustrative data storage devices 910 may be embodied as any type of devices configured for short-term or long-term storage of data such as, for example, memory devices and circuits, memory cards, hard disk drives, solid-state drives, or other data storage devices. Individual data storage devices 910 may include a system partition that stores data and firmware code for the data storage device 910. Individual data storage devices 910 may also include one or more operating system partitions that store data files and executables for operating systems depending on, for example, the type of compute node 900.

The communication circuitry 912 may be embodied as any communication circuit, device, or collection thereof, capable of enabling communications over a network between the compute circuitry 902 and another compute device (e.g., an edge gateway of an implementing edge computing system). The communication circuitry 912 may be configured to use any one or more communication technology (e.g., wired or wireless communications) and associated protocols (e.g., a cellular networking protocol such a 3GPP 4G or 5G standard, a wireless local area network protocol such as IEEE 802.11/Wi-Fi®, a wireless wide area network protocol, Ethernet, Bluetooth®, Bluetooth Low Energy, a IoT protocol such as IEEE 802.15.4 or ZigBee®, low-power wide-area network (LPWAN) or low-power wide-area (LPWA) protocols, etc.) to effect such communication.

The illustrative communication circuitry 912 includes a network interface controller (NIC) 920, which may also be referred to as a host fabric interface (HFI). The NIC 920 may be embodied as one or more add-in-boards, daughter cards, network interface cards, controller chips, chipsets, or other devices that may be used by the compute node 900 to connect with another compute device (e.g., an edge gateway node). In some examples, the NIC 920 may be embodied as part of a system-on-a-chip (SoC) that includes one or more processors, or included on a multichip package that also contains one or more processors. In some examples, the NIC 920 may include a local processor (not shown) and/or a local memory (not shown) that are both local to the NIC 920. In such examples, the local processor of the NIC 920 may be capable of performing one or more of the functions of the compute circuitry 902 described herein. Additionally, or alternatively, in such examples, the local memory of the NIC 920 may be integrated into one or more components of the client compute node at the board level, socket level, chip level, and/or other levels.

Additionally, in some examples, a respective compute node 900 may include one or more peripheral devices 914. Such peripheral devices 914 may include any type of peripheral device found in a compute device or server such as audio input devices, a display, other input/output devices, interface devices, and/or other peripheral devices, depending on the particular type of the compute node 900. In further examples, the compute node 900 may be embodied by a respective edge compute node (whether a client, gateway, or aggregation node) in an edge computing system or like forms of appliances, computers, subsystems, circuitry, or other components.

In a more detailed example, FIG. 9B illustrates a block diagram of an example of components that may be present in an edge computing node 950 for implementing the techniques (e.g., operations, processes, methods, and methodologies) described herein. This edge computing node 950 provides a closer view of the respective components of node 900 when implemented as or as part of a computing device (e.g., as a mobile device, a base station, server, gateway, etc.). The edge computing node 950 may include any combinations of the hardware or logical components referenced herein, and it may include or couple with any device usable with an edge communication network or a combination of such networks. The components may be implemented as integrated circuits (ICs), portions thereof, discrete electronic devices, or other modules, instruction sets, programmable logic or algorithms, hardware, hardware accelerators, software, firmware, or a combination thereof adapted in the edge computing node 950, or as components otherwise incorporated within a chassis of a larger system.

The edge computing device 950 may include processing circuitry in the form of a processor 952, which may be a microprocessor, a multi-core processor, a multithreaded processor, an ultra-low voltage processor, an embedded processor, an xPU/DPU/IPU/NPU, special purpose processing unit, specialized processing unit, or other known processing elements. The processor 952 may be a part of a system on a chip (SoC) in which the processor 952 and other components are formed into a single integrated circuit, or a single package, such as the Edison™ or Galileo™ SoC boards from Intel Corporation, Santa Clara, Calif. As an example, the processor 952 may include an Intel® Architecture Core™ based CPU processor, such as a Quark™, an Atom™, an i3, an i5, an i7, an i9, or an MCU-class processor, or another such processor available from Intel®. However, any number other processors may be used, such as available from Advanced Micro Devices, Inc. (AMD®) of Sunnyvale, Calif., a MIPS®-based design from MIPS Technologies, Inc. of Sunnyvale, Calif., an ARM®-based design licensed from ARM Holdings, Ltd. or a customer thereof, or their licensees or adopters. The processors may include units such as an A5-A13 processor from Apple® Inc., a Snapdragon™ processor from Qualcomm® Technologies, Inc., or an OMAP™ processor from Texas Instruments, Inc. The processor 952 and accompanying circuitry may be provided in a single socket form factor, multiple socket form factor, or a variety of other formats, including in limited hardware configurations or configurations that include fewer than all elements shown in FIG. 9B.

The processor 952 may communicate with a system memory 954 over an interconnect 956 (e.g., a bus). Any number of memory devices may be used to provide for a given amount of system memory. As examples, the memory 754 may be random access memory (RAM) in accordance with a Joint Electron Devices Engineering Council (JEDEC) design such as the DDR or mobile DDR standards (e.g., LPDDR, LPDDR2, LPDDR3, or LPDDR4). In particular examples, a memory component may comply with a DRAM standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Such standards (and similar standards) may be referred to as DDR-based standards and communication interfaces of the storage devices that implement such standards may be referred to as DDR-based interfaces. In various implementations, the individual memory devices may be of any number of different package types such as single die package (SDP), dual die package (DDP) or quad die package (Q17P). These devices, in some examples, may be directly soldered onto a motherboard to provide a lower profile solution, while in other examples the devices are configured as one or more memory modules that in turn couple to the motherboard by a given connector. Any number of other memory implementations may be used, such as other types of memory modules, e.g., dual inline memory modules (DIMMs) of different varieties including but not limited to microDIMMs or MiniDIMMs.

To provide for persistent storage of information such as data, applications, operating systems and so forth, a storage 958 may also couple to the processor 952 via the interconnect 956. In an example, the storage 958 may be implemented via a solid-state disk drive (SSDD). Other devices that may be used for the storage 958 include flash memory cards, such as Secure Digital (SD) cards, microSD cards, eXtreme Digital (XD) picture cards, and the like, and Universal Serial Bus (USB) flash drives. In an example, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

In low power implementations, the storage 958 may be on-die memory or registers associated with the processor 952. However, in some examples, the storage 958 may be implemented using a micro hard disk drive (HDD). Further, any number of new technologies may be used for the storage 958 in addition to, or instead of, the technologies described, such resistance change memories, phase change memories, holographic memories, or chemical memories, among others.

The components may communicate over the interconnect 956. The interconnect 956 may include any number of technologies, including industry standard architecture (ISA), extended ISA (EISA), peripheral component interconnect (PCI), peripheral component interconnect extended (PCIx), PCI express (PCIe), or any number of other technologies. The interconnect 956 may be a proprietary bus, for example, used in an SoC based system. Other bus systems may be included, such as an Inter-Integrated Circuit (I2C) interface, a Serial Peripheral Interface (SPI) interface, point to point interfaces, and a power bus, among others.

The interconnect 956 may couple the processor 952 to a transceiver 966, for communications with the connected edge devices 962. The transceiver 966 may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee® standard, among others. Any number of radios, configured for a particular wireless communication protocol, may be used for the connections to the connected edge devices 962. For example, a wireless local area network (WLAN) unit may be used to implement Wi-Fi® communications in accordance with the Institute of Electrical and Electronics Engineers (IEEE) 802.11 standard. In addition, wireless wide area communications, e.g., according to a cellular or other wireless wide area protocol, may occur via a wireless wide area network (WWAN) unit.

The wireless network transceiver 966 (or multiple transceivers) may communicate using multiple standards or radios for communications at a different range. For example, the edge computing node 950 may communicate with close devices, e.g., within about 10 meters, using a local transceiver based on Bluetooth Low Energy (BLE), or another low power radio, to save power. More distant connected edge devices 962, e.g., within about 50 meters, may be reached over ZigBee® or other intermediate power radios. Both communications techniques may take place over a single radio at different power levels or may take place over separate transceivers, for example, a local transceiver using BLE and a separate mesh transceiver using ZigBee®.

A wireless network transceiver 966 (e.g., a radio transceiver) may be included to communicate with devices or services in a cloud (e.g., an edge cloud 995) via local or wide area network protocols. The wireless network transceiver 966 may be a low-power wide-area (LPWA) transceiver that follows the IEEE 802.15.4, or IEEE 802.15.4g standards, among others. The edge computing node 950 may communicate over a wide area using LoRaWAN™ (Long Range Wide Area Network) developed by Semtech and the LoRa Alliance. The techniques described herein are not limited to these technologies but may be used with any number of other cloud transceivers that implement long range, low bandwidth communications, such as Sigfox, and other technologies. Further, other communications techniques, such as time-slotted channel hopping, described in the IEEE 802.15.4e specification may be used.

Any number of other radio communications and protocols may be used in addition to the systems mentioned for the wireless network transceiver 966, as described herein. For example, the transceiver 966 may include a cellular transceiver that uses spread spectrum (SPA/SAS) communications for implementing high-speed communications. Further, any number of other protocols may be used, such as Wi-Fi® networks for medium speed communications and provision of network communications. The transceiver 966 may include radios that are compatible with any number of 3GPP (Third Generation Partnership Project) specifications, such as Long Term Evolution (LTE) and 5th Generation (5G) communication systems, discussed in further detail at the end of the present disclosure. A network interface controller (NIC) 968 may be included to provide a wired communication to nodes of the edge cloud 995 or to other devices, such as the connected edge devices 962 (e.g., operating in a mesh). The wired communication may provide an Ethernet connection or may be based on other types of networks, such as Controller Area Network (CAN), Local Interconnect Network (LIN), DeviceNet, ControlNet, Data Highway+, PROFIBUS, or PROFINET, among many others. An additional NIC 968 may be included to enable connecting to a second network, for example, a first NIC 968 providing communications to the cloud over Ethernet, and a second NIC 968 providing communications to other devices over another type of network.

Given the variety of types of applicable communications from the device to another component or network, applicable communications circuitry used by the device may include or be embodied by any one or more of components 964, 966, 968, or 970. Accordingly, in various examples, applicable means for communicating (e.g., receiving, transmitting, etc.) may be embodied by such communications circuitry.

The edge computing node 950 may include or be coupled to acceleration circuitry 964, which may be embodied by one or more artificial intelligence (AI) accelerators, a neural compute stick, neuromorphic hardware, an FPGA, an arrangement of GPUs, an arrangement of xPUs/DPUs/IPU/NPUs, one or more SoCs, one or more CPUs, one or more digital signal processors, dedicated ASICs, or other forms of specialized processors or circuitry designed to accomplish one or more specialized tasks. These tasks may include AI processing (including machine learning, training, inferencing, and classification operations), visual data processing, network data processing, object detection, rule analysis, or the like. These tasks also may include the specific edge computing tasks for service management and service operations discussed elsewhere in this document.

The interconnect 956 may couple the processor 952 to a sensor hub or external interface 970 that is used to connect additional devices or subsystems. The devices may include sensors 972, such as accelerometers, level sensors, flow sensors, optical light sensors, camera sensors, temperature sensors, global navigation system (e.g., GPS) sensors, pressure sensors, barometric pressure sensors, and the like. The hub or interface 970 further may be used to connect the edge computing node 950 to actuators 974, such as power switches, valve actuators, an audible sound generator, a visual warning device, and the like.

In some optional examples, various input/output (I/O) devices may be present within or connected to, the edge computing node 950. For example, a display or other output device 984 may be included to show information, such as sensor readings or actuator position. An input device 986, such as a touch screen or keypad may be included to accept input. An output device 984 may include any number of forms of audio or visual display, including simple visual outputs such as binary status indicators (e.g., light-emitting diodes (LEDs)) and multi-character visual outputs, or more complex outputs such as display screens (e.g., liquid crystal display (LCD) screens), with the output of characters, graphics, multimedia objects, and the like being generated or produced from the operation of the edge computing node 950. A display or console hardware, in the context of the present system, may be used to provide output and receive input of an edge computing system; to manage components or services of an edge computing system; identify a state of an edge computing component or service; or to conduct any other number of management or administration functions or service use cases.

A battery 976 may power the edge computing node 950, although, in examples in which the edge computing node 950 is mounted in a fixed location, it may have a power supply coupled to an electrical grid, or the battery may be used as a backup or for temporary capabilities. The battery 976 may be a lithium ion battery, or a metal-air battery, such as a zinc-air battery, an aluminum-air battery, a lithium-air battery, and the like.

A battery monitor/charger 978 may be included in the edge computing node 950 to track the state of charge (SoCh) of the battery 976, if included. The battery monitor/charger 978 may be used to monitor other parameters of the battery 976 to provide failure predictions, such as the state of health (SoH) and the state of function (SoF) of the battery 976. The battery monitor/charger 978 may include a battery monitoring integrated circuit, such as an LTC4020 or an LTC2990 from Linear Technologies, an ADT7488A from ON Semiconductor of Phoenix Ariz., or an IC from the UCD90xxx family from Texas Instruments of Dallas, Tex. The battery monitor/charger 978 may communicate the information on the battery 976 to the processor 952 over the interconnect 956. The battery monitor/charger 978 may also include an analog-to-digital (ADC) converter that enables the processor 952 to directly monitor the voltage of the battery 976 or the current flow from the battery 976. The battery parameters may be used to determine actions that the edge computing node 950 may perform, such as transmission frequency, mesh network operation, sensing frequency, and the like.

A power block 980, or other power supply coupled to a grid, may be coupled with the battery monitor/charger 978 to charge the battery 976. In some examples, the power block 980 may be replaced with a wireless power receiver to obtain the power wirelessly, for example, through a loop antenna in the edge computing node 950. A wireless battery charging circuit, such as an LTC4020 chip from Linear Technologies of Milpitas, Calif., among others, may be included in the battery monitor/charger 978. The specific charging circuits may be selected based on the size of the battery 976, and thus, the current required. The charging may be performed using the Airfuel standard promulgated by the Airfuel Alliance, the Qi wireless charging standard promulgated by the Wireless Power Consortium, or the Rezence charging standard, promulgated by the Alliance for Wireless Power, among others.

The storage 958 may include instructions 982 in the form of software, firmware, or hardware commands to implement the techniques described herein. Although such instructions 982 are shown as code blocks included in the memory 954 and the storage 958, it may be understood that any of the code blocks may be replaced with hardwired circuits, for example, built into an application specific integrated circuit (ASIC).

In an example, the instructions 982 provided via the memory 954, the storage 958, or the processor 952 may be embodied as a non-transitory, machine-readable medium 960 including code to direct the processor 952 to perform electronic operations in the edge computing node 950. The processor 952 may access the non-transitory, machine-readable medium 960 over the interconnect 956. For instance, the non-transitory, machine-readable medium 960 may be embodied by devices described for the storage 958 or may include specific storage units such as optical disks, flash drives, or any number of other hardware devices. The non-transitory, machine-readable medium 960 may include instructions to direct the processor 952 to perform a specific sequence or flow of actions, for example, as described with respect to the flowchart(s) and block diagram(s) of operations and functionality depicted above. As used herein, the terms “machine-readable medium” and “computer-readable medium” are interchangeable.

Also in a specific example, the instructions 982 on the processor 952 (separately, or in combination with the instructions 982 of the machine readable medium 960) may configure execution or operation of a trusted execution environment (TEE) 990. In an example, the TEE 990 operates as a protected area accessible to the processor 952 for secure execution of instructions and secure access to data. Various implementations of the TEE 990, and an accompanying secure area in the processor 952 or the memory 954 may be provided, for instance, through use of Intel® Software Guard Extensions (SGX) or ARM® TrustZone® hardware security extensions, Intel® Management Engine (ME), or Intel® Converged Security Manageability Engine (CSME). Other aspects of security hardening, hardware roots-of-trust, and trusted or protected operations may be implemented in the device 950 through the TEE 990 and the processor 952.

Software Distribution Embodiments

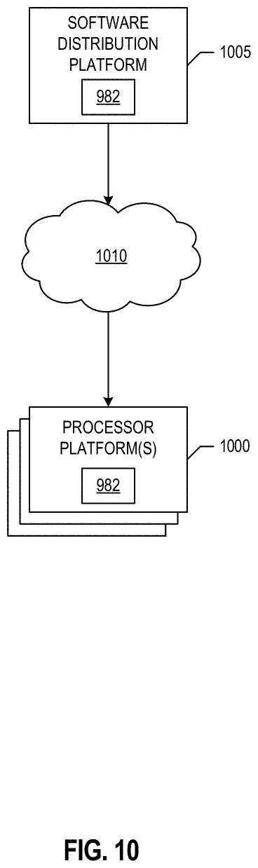

FIG. 10 illustrates an example software distribution platform 1005 to distribute software, such as the example computer readable instructions 982 of FIG. 9B, to one or more devices, such as example processor platform(s) 1000 and/or example connected edge devices described throughout this disclosure. The example software distribution platform 1005 may be implemented by any computer server, data facility, cloud service, etc., capable of storing and transmitting software to other computing devices (e.g., third parties, example connected edge devices described throughout this disclosure). Example connected edge devices may be customers, clients, managing devices (e.g., servers), third parties (e.g., customers of an entity owning and/or operating the software distribution platform 1005). Example connected edge devices may operate in commercial and/or home automation environments. In some examples, a third party is a developer, a seller, and/or a licensor of software such as the example computer readable instructions 982 of FIG. 9B. The third parties may be consumers, users, retailers, OEMs, etc. that purchase and/or license the software for use and/or re-sale and/or sub-licensing. In some examples, distributed software causes display of one or more user interfaces (Uls) and/or graphical user interfaces (GUIs) to identify the one or more devices (e.g., connected edge devices) geographically and/or logically separated from each other (e.g., physically separated IoT devices chartered with the responsibility of water distribution control (e.g., pumps), electricity distribution control (e.g., relays), etc.).

In the illustrated example of FIG. 10, the software distribution platform 1005 includes one or more servers and one or more storage devices. The storage devices store the computer readable instructions 982, which may implement the video processing functionality described throughout this disclosure. The one or more servers of the example software distribution platform 1005 are in communication with a network 1010, which may correspond to any one or more of the Internet and/or any of the example networks described throughout this disclosure. In some examples, the one or more servers are responsive to requests to transmit the software to a requesting party as part of a commercial transaction. Payment for the delivery, sale and/or license of the software may be handled by the one or more servers of the software distribution platform and/or via a third-party payment entity. The servers enable purchasers and/or licensors to download the computer readable instructions 982 from the software distribution platform 1005. For example, software comprising the computer readable instructions 982 may be downloaded to the example processor platform(s) 1000 (e.g., example connected edge devices), which is/are to execute the computer readable instructions 982 to implement the functionality described throughout this disclosure. In some examples, one or more servers of the software distribution platform 1005 are communicatively connected to one or more security domains and/or security devices through which requests and transmissions of the example computer readable instructions 982 must pass. In some examples, one or more servers of the software distribution platform 1005 periodically offer, transmit, and/or force updates to the software (e.g., the example computer readable instructions 982 of FIG. 9B) to ensure improvements, patches, updates, etc. are distributed and applied to the software at the end user devices.

Terminology

As used herein, the term “edge computing” encompasses many implementations of distributed computing that move processing activities and resources (e.g., compute, storage, acceleration resources), including those typically performed as cloud processing activities or by cloud processing resources, towards the “edge” of the network in an effort to reduce latency and increase throughput for endpoint users (client devices, user equipment, etc.). Such edge computing implementations typically involve the offering of such activities and resources in cloud-like services, functions, applications, and subsystems, from one or multiple locations accessible via wireless networks. Thus, the references to an “edge” of a network, cluster, domain, system or computing arrangement used herein are groups or groupings of functional distributed compute elements and, therefore, generally unrelated to “edges” (links or connections) as used in graph theory.

Specific arrangements of edge computing applications and services accessible via mobile wireless networks (e.g., cellular and Wi-Fi data networks) may be referred to as “mobile edge computing” or “multi-access edge computing”, which may be referenced by the acronym “MEC”. The usage of “MEC” herein may also refer to a standardized implementation promulgated by the European Telecommunications Standards Institute (ETSI), referred to as “ETSI MEC”. Terminology that is used by the ETSI MEC specification is generally incorporated herein by reference, unless a conflicting definition or usage is provided herein.

As used herein, the term “compute node” or “compute device” refers to an identifiable entity implementing an aspect of edge computing operations, whether part of a larger system, distributed collection of systems, or a standalone apparatus. In some examples, a compute node may be referred to as a “edge node”, “edge device”, “edge system”, whether in operation as a client, server, or intermediate entity. Specific implementations of a compute node may be incorporated into a server, base station, gateway, road side unit, on premise unit, UE or end consuming device, or the like. Additionally, a compute node or compute device may encompass different types or classes of hardware, or configurations of such hardware, based on the resources available to the node or device (e.g., power, compute, space, temperature, and other operational considerations or constraints). Thus, many variations of hardware are intended to be encompassed by a compute node or compute device.

As used herein, the term “base station” refers to a network element in a radio access network (RAN), such as a fourth-generation (4G) or fifth-generation (5G) mobile communications network which is responsible for the transmission and reception of radio signals in one or more cells to or from a user equipment (UE). A base station can have an integrated antenna or may be connected to an antenna array by feeder cables. A base station uses specialized digital signal processing and network function hardware. In some examples, the base station may be split into multiple functional blocks operating in software for flexibility, monetary or resource cost, and performance. In some examples, a base station can include an evolved node-B (eNB) or a next generation node-B (gNB). In some examples, the base station may operate or include compute hardware to operate as a compute node. However, in many of the scenarios discussed herein, a RAN base station may be substituted with an access point (e.g., wireless network access point) or other network access hardware.

As used herein, the term “central office” (or CO) indicates an aggregation point for telecommunications infrastructure within an accessible or defined geographical area, often where telecommunication service providers have traditionally located switching equipment for one or multiple types of access networks. The CO can be physically designed to house telecommunications infrastructure equipment or compute, data storage, and network resources. The CO need not, however, be a designated location by a telecommunications service provider. The CO may host any number of compute devices for edge applications and services, or even local implementations of cloud-like services.

As used herein, the term “cloud service provider” (or CSP) indicates an organization which operates typically large-scale “cloud” resources comprised of centralized, regional, and edge data centers (e.g., as used in the context of the public cloud). In other examples, a CSP may also be referred to as a Cloud Service Operator (CSO). References to “cloud computing” generally refer to computing resources and services offered by a CSP or a CSO, at remote locations with at least some increased latency, distance, or constraints relative to edge computing.

As used herein, the term “data center” refers to a purpose-designed structure that is intended to house multiple high-performance compute and data storage nodes such that a large amount of compute, data storage and network resources are present at a single location. This often entails specialized rack and enclosure systems, suitable heating, cooling, ventilation, security, fire suppression, and power delivery systems. The term may also refer to a compute and data storage node in some contexts. A data center may vary in scale between a centralized or cloud data center (e.g., largest), regional data center, and edge data center (e.g., smallest).

As used herein, references to a “layer” of an edge network may encompass various forms or types of edge networks and edge networking configurations that have common properties relating to latency, timing, or distance, whether termed as “close edge”, “local edge”, “middle edge”, “far edge”, or with use of specifically named layers. Thus, a reference to a layer typically does not necessarily refer to a layer in the OSI model but rather will refer to some network portion or segment with a common tier or set of properties.

As used herein, the term “access edge layer” indicates the sub-layer of infrastructure edge closest to the end user or device. For example, such layer may be fulfilled by an edge data center deployed at a cellular network site. The access edge layer functions as the front line of the infrastructure edge and may connect to an aggregation edge layer higher in the hierarchy. As also used herein, the term “aggregation edge layer” indicates the layer of infrastructure edge one hop away from the access edge layer. This layer can exist as either a medium-scale data center in a single location or may be formed from multiple interconnected micro data centers to form a hierarchical topology with the access edge to allow for greater collaboration, workload failover, and scalability than access edge alone.

As used herein, the term “network function virtualization” (or NFV) indicates the migration of network functions from embedded services inside proprietary hardware appliances to software-based virtualized network functions (or VNFs) running on standardized CPUs (e.g., within standard x86® and ARM® servers, such as those including Intel® Xeon™ or AMD® Epyc™ or Opteron™ processors) using industry standard virtualization and cloud computing technologies. In some aspects, NFV processing and data storage will occur at the edge data centers that are connected directly to the local cellular site, within the infrastructure edge.

As used herein, the term “virtualized network function” (or VNF) indicates a software-based network function operating on multi-function, multi-purpose compute resources (e.g., x86, ARM processing architecture) which are used by NFV in place of dedicated physical equipment. In some aspects, several VNFs will operate on an edge data center at the infrastructure edge.

As used herein, the term “edge compute node” refers to a real-world, logical, or virtualized implementation of a compute-capable element in the form of a device, gateway, bridge, system or subsystem, component, whether operating in a server, client, endpoint, or peer mode, and whether located at an “edge” of an network or at a connected location further within the network. References to a “node” used herein are generally interchangeable with a “device”, “component”, and “sub-system”; however, references to an “edge computing system” generally refer to a distributed architecture, organization, or collection of multiple nodes and devices, and which is organized to accomplish or offer some aspect of services or resources in an edge computing setting.

As used herein, the term “cluster” refers to a set or grouping of entities as part of an edge computing system (or systems), in the form of physical entities (e.g., different computing systems, networks or network groups), logical entities (e.g., applications, functions, security constructs, containers), and the like. In some locations, a “cluster” is also referred to as a “group” or a “domain”. The membership of cluster may be modified or affected based on conditions or functions, including from dynamic or property-based membership, from network or system management scenarios, or from various example techniques discussed below which may add, modify, or remove an entity in a cluster. Clusters may also include or be associated with multiple layers, levels, or properties, including variations in security features and results based on such layers, levels, or properties.

### EXAMPLES

Illustrative examples of the technologies described throughout this disclosure are provided below. Embodiments of these technologies may include any one or more, and any combination of, the examples described below. In some embodiments, at least one of the systems or components set forth in one or more of the preceding figures may be configured to perform one or more operations, techniques, processes, and/or methods as set forth in the following examples.

Example 1 includes a computing device, comprising: interface circuitry; and processing circuitry to: receive, via the interface circuitry, a data stream captured at least partially by one or more sensors, wherein the data stream comprises a set of feature values corresponding to an unlabeled instance of a feature set; group the data stream into a data stream group, wherein the data stream group is assigned from a set of data stream groups based on the set of feature values in the data stream; select, from a set of predictive models, a predictive model corresponding to the data stream group assigned to the data stream, wherein each predictive model in the set of predictive models is trained to predict a target variable for a corresponding data stream group in the set of data stream groups; and predict the target variable for the data stream using the predictive model, wherein the predictive model infers the target variable based on the set of feature values in the data stream.

Example 2 includes the computing device of Example 1, wherein the processing circuitry is further to: train the set of predictive models to predict the target variable for the set of data stream groups based on a training dataset, wherein the training dataset comprises a set of training data streams assigned to the set of data stream groups, wherein each predictive model is trained to predict the target variable for the corresponding data stream group based on a corresponding subset of training data streams from the training dataset.

Example 3 includes the computing device of any of Examples 1-2, wherein the processing circuitry to group the data stream into the data stream group is further to: select the data stream group to assign to the data stream using a grouping model, wherein the grouping model selects the data stream group from the set of data stream groups based on a comparison of the data stream to a grouping dataset, wherein the grouping dataset comprises a set of representative data streams for each data stream group in the set of data stream groups.

Example 4 includes the computing device of Example 3, wherein the processing circuitry to select the data stream group to assign to the data stream using the grouping model is further to: compute, based on a distance calculation, a distance of the data stream to each data stream group in the set of data stream groups, wherein the distance to each data stream group is computed based on the set of representative data streams for each data stream group; and select, from the set of data stream groups, the data stream group having a closest distance to the data stream.

Example 5 includes the computing device of any of Examples 3-4, wherein the grouping model comprises a clustering model.

Example 6 includes the computing device of any of Examples 3-5, wherein the processing circuitry is further to: select the set of representative data streams for each data stream group from a training dataset, wherein the training dataset comprises a set of training data streams; and generate the grouping dataset for the grouping model, wherein the grouping dataset comprises the set of representative data streams selected for each data stream group.

Example 7 includes the computing device of any of Examples 1-6, wherein the processing circuitry is further to: detect a change in the set of feature values in the data stream; determine, based on the change in the set of feature values, that a grouping of the data stream is to be updated, wherein the data stream is to be reassigned to a second data stream group in the set of data stream groups; and

dynamically update the set of data stream groups to reassign the data stream to the second data stream group.

Example 8 includes the computing device of any of Examples 1-7, wherein: the computing device is: an edge server; a tool controller to control a tool; or a robot controller to control a robot; and the target variable comprises a predicted quality level of a task performed by the tool or the robot.

Example 9 includes at least one non-transitory computer-readable storage medium having instructions stored thereon, wherein the instructions, when executed on processing circuitry, cause the processing circuitry to: receive, via interface circuitry, a data stream captured at least partially by one or more sensors, wherein the data stream comprises a set of feature values corresponding to an unlabeled instance of a feature set; group the data stream into a data stream group, wherein the data stream group is assigned from a set of data stream groups based on the set of feature values in the data stream; select, from a set of predictive models, a predictive model corresponding to the data stream group assigned to the data stream, wherein each predictive model in the set of predictive models is trained to predict a target variable for a corresponding data stream group in the set of data stream groups; and predict the target variable for the data stream using the predictive model, wherein the predictive model infers the target variable based on the set of feature values in the data stream.

Example 10 includes the storage medium of Example 9, wherein the instructions further cause the processing circuitry to: train the set of predictive models to predict the target variable for the set of data stream groups based on a training dataset, wherein the training dataset comprises a set of training data streams assigned to the set of data stream groups, wherein each predictive model is trained to predict the target variable for the corresponding data stream group based on a corresponding subset of training data streams from the training dataset.

Example 11 includes the storage medium of any of Examples 9-10, wherein the instructions that cause the processing circuitry to group the data stream into the data stream group further cause the processing circuitry to: select the data stream group to assign to the data stream using a grouping model, wherein the grouping model selects the data stream group from the set of data stream groups based on a comparison of the data stream to a grouping dataset, wherein the grouping dataset comprises a set of representative data streams for each data stream group in the set of data stream groups.

Example 12 includes the storage medium of Example 11, wherein the instructions that cause the processing circuitry to select the data stream group to assign to the data stream using the grouping model further cause the processing circuitry to: compute, based on a distance calculation, a distance of the data stream to each data stream group in the set of data stream groups, wherein the distance to each data stream group is computed based on the set of representative data streams for each data stream group; and select, from the set of data stream groups, the data stream group having a closest distance to the data stream.

Example 13 includes the storage medium of Example 12, wherein the distance calculation comprises: a Euclidean distance calculation; a Jaccard calculation; or a dynamic time warping calculation.

Example 14 includes the storage medium of any of Examples 11-13, wherein the grouping model comprises a clustering model.

Example 15 includes the storage medium of Example 14, wherein the clustering model comprises a k-means clustering model.

Example 16 includes the storage medium of any of Examples 11-15, wherein the instructions further cause the processing circuitry to: select the set of representative data streams for each data stream group from a training dataset, wherein the training dataset comprises a set of training data streams; and generate the grouping dataset for the grouping model, wherein the grouping dataset comprises the set of representative data streams selected for each data stream group.

Example 17 includes the storage medium of any of Examples 9-16, wherein the instructions further cause the processing circuitry to: detect a change in the set of feature values in the data stream; determine, based on the change in the set of feature values, that a grouping of the data stream is to be updated, wherein the data stream is to be reassigned to a second data stream group in the set of data stream groups; and dynamically update the set of data stream groups to reassign the data stream to the second data stream group.

Example 18 includes the storage medium of any of Examples 9-17, wherein the target variable comprises a predicted quality level of a task performed by a machine.

Example 19 includes the storage medium of Example 18, wherein the task comprises a manufacturing task performed to manufacture a product.

Example 20 includes a method of performing predictive analytics, comprising: receiving a data stream captured at least partially by one or more sensors, wherein the data stream comprises a set of feature values corresponding to an unlabeled instance of a feature set; grouping the data stream into a data stream group, wherein the data stream group is assigned from a set of data stream groups based on the set of feature values in the data stream; selecting, from a set of predictive models, a predictive model corresponding to the data stream group assigned to the data stream, wherein each predictive model in the set of predictive models is trained to predict a target variable for a corresponding data stream group in the set of data stream groups; and predicting the target variable for the data stream using the predictive model, wherein the predictive model infers the target variable based on the set of feature values in the data stream.

Example 21 includes the method of Example 20, further comprising: training the set of predictive models to predict the target variable for the set of data stream groups based on a training dataset, wherein the training dataset comprises a set of training data streams assigned to the set of data stream groups, wherein each predictive model is trained to predict the target variable for the corresponding data stream group based on a corresponding subset of training data streams from the training dataset.

Example 22 includes the method of any of Examples 20-21, further comprising: detecting a change in the set of feature values in the data stream; determining, based on the change in the set of feature values, that a grouping of the data stream is to be updated, wherein the data stream is to be reassigned to a second data stream group in the set of data stream groups; and dynamically updating the set of data stream groups to reassign the data stream to the second data stream group.

Example 23 includes a system, comprising: one or more sensors; interface circuitry; and processing circuitry to: receive, via the interface circuitry, a data stream captured at least partially by the one or more sensors, wherein the data stream comprises a set of feature values corresponding to an unlabeled instance of a feature set; group the data stream into a data stream group, wherein the data stream group is assigned from a set of data stream groups based on the set of feature values in the data stream; select, from a set of predictive models, a predictive model corresponding to the data stream group assigned to the data stream, wherein each predictive model in the set of predictive models is trained to predict a target variable for a corresponding data stream group in the set of data stream groups; and predict the target variable for the data stream using the predictive model, wherein the predictive model infers the target variable based on the set of feature values in the data stream.

Example 24 includes the system of Example 23, wherein: the system is a tool or a robot; and the target variable comprises a predicted quality level of a task performed by the tool or the robot.

Example 25 includes the system of Example 24, wherein the tool is: a welding gun; a glue gun; a riveting machine; a screwdriver; or a pump.

Numerous other changes, substitutions, variations, alterations, and modifications may be ascertained to one skilled in the art and it is intended that the present disclosure encompass all such changes, substitutions, variations, alterations, and modifications as falling within the scope of the appended claims.

What is claimed is:

1. A computing device, comprising:
interface circuitry; and
processing circuitry to:
receive, via the interface circuitry, a data stream captured at least partially by one or more sensors, wherein the data stream comprises a set of feature values corresponding to an unlabeled instance of a feature set;
group the data stream into a data stream group, wherein the data stream group is assigned from a set of data stream groups based on the set of feature values in the data stream;
select, from a set of predictive models, a predictive model corresponding to the data stream group assigned to the data stream, wherein each predictive model in the set of predictive models is trained to predict a target variable for a corresponding data stream group in the set of data stream groups; and
predict the target variable for the data stream using the predictive model, wherein the predictive model infers the target variable based on the set of feature values in the data stream.

2. The computing device of claim 1, wherein the processing circuitry is further to:
train the set of predictive models to predict the target variable for the set of data stream groups based on a training dataset, wherein the training dataset comprises a set of training data streams assigned to the set of data stream groups, wherein each predictive model is trained to predict the target variable for the corresponding data stream group based on a corresponding subset of training data streams from the training dataset.

3. The computing device of claim 1, wherein the processing circuitry to group the data stream into the data stream group is further to:
select the data stream group to assign to the data stream using a grouping model, wherein the grouping model selects the data stream group from the set of data stream groups based on a comparison of the data stream to a grouping dataset, wherein the grouping dataset comprises a set of representative data streams for each data stream group in the set of data stream groups.

4. The computing device of claim 3, wherein the processing circuitry to select the data stream group to assign to the data stream using the grouping model is further to:
compute, based on a distance calculation, a distance of the data stream to each data stream group in the set of data stream groups, wherein the distance to each data stream group is computed based on the set of representative data streams for each data stream group; and
select, from the set of data stream groups, the data stream group having a closest distance to the data stream.

5. The computing device of claim 3, wherein the grouping model comprises a clustering model.

6. The computing device of claim 3, wherein the processing circuitry is further to:
select the set of representative data streams for each data stream group from a training dataset, wherein the training dataset comprises a set of training data streams; and
generate the grouping dataset for the grouping model, wherein the grouping dataset comprises the set of representative data streams selected for each data stream group.

7. The computing device of claim 1, wherein the processing circuitry is further to:
detect a change in the set of feature values in the data stream;
determine, based on the change in the set of feature values, that a grouping of the data stream is to be updated, wherein the data stream is to be reassigned to a second data stream group in the set of data stream groups; and
dynamically update the set of data stream groups to reassign the data stream to the second data stream group.

8. The computing device of claim 1, wherein:
the computing device is:
an edge server;
a tool controller to control a tool; or
a robot controller to control a robot; and
the target variable comprises a predicted quality level of a task performed by the tool or the robot.

9. At least one non-transitory computer-readable storage medium having instructions stored thereon, wherein the instructions, when executed on processing circuitry, cause the processing circuitry to:
receive, via interface circuitry, a data stream captured at least partially by one or more sensors, wherein the data stream comprises a set of feature values corresponding to an unlabeled instance of a feature set;
group the data stream into a data stream group, wherein the data stream group is assigned from a set of data stream groups based on the set of feature values in the data stream;
select, from a set of predictive models, a predictive model corresponding to the data stream group assigned to the data stream, wherein each predictive model in the set of predictive models is trained to predict a target variable for a corresponding data stream group in the set of data stream groups; and
predict the target variable for the data stream using the predictive model, wherein the predictive model infers the target variable based on the set of feature values in the data stream.

10. The storage medium of claim 9, wherein the instructions further cause the processing circuitry to:
train the set of predictive models to predict the target variable for the set of data stream groups based on a training dataset, wherein the training dataset comprises a set of training data streams assigned to the set of data stream groups, wherein each predictive model is trained to predict the target variable for the corresponding data stream group based on a corresponding subset of training data streams from the training dataset.

11. The storage medium of claim 9, wherein the instructions that cause the processing circuitry to group the data stream into the data stream group further cause the processing circuitry to:
select the data stream group to assign to the data stream using a grouping model, wherein the grouping model selects the data stream group from the set of data stream groups based on a comparison of the data stream to a grouping dataset, wherein the grouping dataset comprises a set of representative data streams for each data stream group in the set of data stream groups.

12. The storage medium of claim 11, wherein the instructions that cause the processing circuitry to select the data stream group to assign to the data stream using the grouping model further cause the processing circuitry to:
compute, based on a distance calculation, a distance of the data stream to each data stream group in the set of data stream groups, wherein the distance to each data stream group is computed based on the set of representative data streams for each data stream group; and
select, from the set of data stream groups, the data stream group having a closest distance to the data stream.

13. The storage medium of claim 12, wherein the distance calculation comprises:
a Euclidean distance calculation;
a Jaccard calculation; or
a dynamic time warping calculation.

14. The storage medium of claim 11, wherein the grouping model comprises a clustering model.

15. The storage medium of claim 14, wherein the clustering model comprises a k-means clustering model.

16. The storage medium of claim 11, wherein the instructions further cause the processing circuitry to:
select the set of representative data streams for each data stream group from a training dataset, wherein the training dataset comprises a set of training data streams; and
generate the grouping dataset for the grouping model, wherein the grouping dataset comprises the set of representative data streams selected for each data stream group.

17. The storage medium of claim 9, wherein the instructions further cause the processing circuitry to:
detect a change in the set of feature values in the data stream;
determine, based on the change in the set of feature values, that a grouping of the data stream is to be updated, wherein the data stream is to be reassigned to a second data stream group in the set of data stream groups; and
dynamically update the set of data stream groups to reassign the data stream to the second data stream group.

18. The storage medium of claim 9, wherein the target variable comprises a predicted quality level of a task performed by a machine.

19. The storage medium of claim 18, wherein the task comprises a manufacturing task performed to manufacture a product.

20. A method of performing predictive analytics, comprising:
receiving a data stream captured at least partially by one or more sensors, wherein the data stream comprises a set of feature values corresponding to an unlabeled instance of a feature set;
grouping the data stream into a data stream group, wherein the data stream group is assigned from a set of data stream groups based on the set of feature values in the data stream;
selecting, from a set of predictive models, a predictive model corresponding to the data stream group assigned to the data stream, wherein each predictive model in the set of predictive models is trained to predict a target variable for a corresponding data stream group in the set of data stream groups; and
predicting the target variable for the data stream using the predictive model, wherein the predictive model infers the target variable based on the set of feature values in the data stream.

21. The method of claim 20, further comprising:
training the set of predictive models to predict the target variable for the set of data stream groups based on a training dataset, wherein the training dataset comprises a set of training data streams assigned to the set of data stream groups, wherein each predictive model is trained to predict the target variable for the corresponding data stream group based on a corresponding subset of training data streams from the training dataset.

22. The method of claim 20, further comprising:
detecting a change in the set of feature values in the data stream;
determining, based on the change in the set of feature values, that a grouping of the data stream is to be updated, wherein the data stream is to be reassigned to a second data stream group in the set of data stream groups; and
dynamically updating the set of data stream groups to reassign the data stream to the second data stream group.

23. A system, comprising:
one or more sensors;
interface circuitry; and
processing circuitry to:
receive, via the interface circuitry, a data stream captured at least partially by the one or more sensors, wherein the data stream comprises a set of feature values corresponding to an unlabeled instance of a feature set;
group the data stream into a data stream group, wherein the data stream group is assigned from a set of data stream groups based on the set of feature values in the data stream;
select, from a set of predictive models, a predictive model corresponding to the data stream group assigned to the data stream, wherein each predictive model in the set of predictive models is trained to predict a target variable for a corresponding data stream group in the set of data stream groups; and
predict the target variable for the data stream using the predictive model, wherein the predictive model infers the target variable based on the set of feature values in the data stream.

24. The system of claim 23, wherein:
the system is a tool or a robot; and
the target variable comprises a predicted quality level of a task performed by the tool or the robot.

25. The system of claim 24, wherein the tool is:
a welding gun;
a glue gun;
a riveting machine;
a screwdriver; or
a pump.
